(19) United States
(12) Patent Application Publication
(10) Pub. No.: US 2025/0174951 A1
(43) Pub. Date: May 29, 2025

(54) TOOL, TOOL INSERT AND GROUP OF TOOLS

(71) Applicant: WEZAG GmbH & Co. KG, Stadtallendorf (DE)

(72) Inventor: Thomas Glockseisen, Düsseldorf (DE)

(73) Assignee: WEZAG GmbH & Co. KG, Stadtallendorf (DE)

(21) Appl. No.: 18/955,631

(22) Filed: Nov. 21, 2024

(30) Foreign Application Priority Data
Nov. 23, 2023 (EP) 23 211 835.6

(51) Int. Cl. H01R 43/042

(52) U.S. Cl. CPC H01R 43/0421

(57) ABSTRACT

The invention relates to a tool comprising a tool insert with a revolver that comprises two pairs of processing bodies that each form an accommodation for a workpiece that comprises a longitudinal axis. The pairs of processing bodies are movable during a processing stroke along a processing axis relative to each other and radially to the longitudinal axis from an open position into a closed position. A tool actuating unit comprises an accommodation for the tool insert and an actuating plunger. The revolver and processing bodies can be rotated together about the rotational axis from a first rotational position into a second rotational position. In the first rotational position, the actuating plunger's actuating surface actuates the actuating surface of one of the first pair of processing bodies. In the second rotational position actuating plunger's actuating surface actuates the actuating surface of one of the second pair of processing bodies.

### CROSS REFERENCE TO RELATED APPLICATIONS

This application claims priority to co-pending European Patent Application No. 23 211 835.6, filed Nov. 23, 2023, the disclosure of which is hereby incorporated herein by reference in its entirety.

### FIELD OF THE INVENTION

The invention relates to a tool which is used, for example, for assembling or trimming cables, wherein the tool can be used, for example, to crimp a connector to the cable and/or to cut or cut through the cable and/or to remove the insolation of the cable for stripping the cable. The tool can be embodied as a (stationary) machine tool, which can be driven electrically, pneumatically or hydraulically. However, the tool can also be a hand tool. In this case, the tool can be held by hand, while the actuating force is generated electrically, pneumatically or hydraulically. It is also possible that the tool is a manually operated hand tool, in which the actuating force is generated by one or two hands operating hand levers.

### BACKGROUND OF THE INVENTION

EP 2 096 725 B1 corresponding to U.S. Pat. No. 8,230,715 B2 describes crimping pliers intended to be used for crimping a pressed part, for example an electrical line connection, a pipe connection, a fitting, a cable shoe or the like. EP 2 096 725 B1 describes known pressing tools in which the pressing takes place between die halves that are held on pliers jaws. In this case, several pairs of die halves can be arranged next to each other on a die body, the pairs of die halves having different cross-sections and/or contours. A user of the pressing tool can then selectively insert a workpiece into one of the pairs of die halves and press the workpiece there. In this way, it should be possible to press different workpieces without having to modify or replace the pressing tool. It is also described in EP 2 096 725 B1 that it is known that different tool inserts with different contours and cross-sections can be inserted into a tool actuation unit. The tool inserts can then be fixed to the pliers jaws of the tool actuating unit via a snap-in connection. Finally, it is described in EP 2 096 725 B1 to be known that pliers jaws of pipe pressing pliers each comprise a rotary die which is mounted rotatably about a rotational axis on the associated pliers jaw (cf. DE 196 287 52 A1 corresponding to U.S. Pat. No. 5,802,908 A). Several die halves with different contours and cross-sections are distributed along the circumference of the rotary die. In order to select a specific pair of die halves, the user has to transfer the rotary dies to the assigned rotary positions in which the selected specific die halves of this pair are arranged opposite to each other. The rotary dies can be arrested in the rotary positions required for the respective operation of the specific die halves of the pair by means of spring-loaded sliders engaging with the rotary dies. Against the background of this prior art, EP 2 092 725 B1 proposes that a tool insert is formed with two insert halves. The insert halves are guided on each other by guide pins in such a way that they can be displaced in translation relative to one another in the direction of a processing axis. The insert halves each comprise several die halves with different contours and cross-sections arranged next to one another, wherein the opposite die halves of the two insert halves form pairs of die halves by means of which different types of workpieces can be processed. The two insert halves guided on each other in this way can then each be slid into a guiding groove of an associated pliers jaw and can be moved in the guiding groove between different operating positions. The different operating positions can each be secured via a latching connection. In each of the different operating positions, a pair of die halves is arranged coaxially to a central axis of the tool, resulting in symmetrical force conditions and a good support. The guiding grooves and thus the degrees of freedom of displacement of the tool insert and of the insert halves are oriented transversely to the processing axis of the crimping tool and lie in a pliers plane in which the hand levers are pivoted and the relative movement of the pliers jaws takes place.

EP 0 468 335 A2 corresponding to U.S. Pat. No. 5,153,984 A discloses crimping pliers by means of which a plug is to be crimped to a cable in two axial sections. In a first axial section, a so-called insulation crimp is to be produced, in the area of which the plug is crimped to the insulation sheath of the conductor. In the second axial section, a so-called conductor crimp is produced, by means of which the plug is crimped to a conductor end of the cable, in the area of which the insulation sheath of the cable has been removed by stripping. Different simultaneously actuated die halves-axial sections are used for the insulation crimp on one side and the conductor crimp on the other.

According to EP 0 468 335 A2, the die halves axial sections are formed by plates arranged at a distance from each other and extending parallel to each other. Plates with the die halves axial sections of the fixed pliers jaw can be rotatably mounted on the pliers head in such a way that die halves axial sections arranged at different edges of a plate can be brought into action. For this purpose, the plate is moved out of lateral guides under the bias of a spring and then reinserted into the lateral guides after being rotated by 90° or 180°. EP 0 468 335 A2 also proposes that a plate held on a movable pliers jaw can be rotated in different angular positions accordingly in order to bring into effect die half axial sections formed on the movable pliers jaw at different edges of the plate.

EP 2 463 969 B1 corresponding to U.S. Pat. No. 8,601,856 B2 discloses crimping pliers in which the two pliers jaws each comprise die halves arranged next to one another, which form pairs of die halves with different die geometries. To simplify the insertion and alignment of the workpiece in the die halves, the crimping pliers have a positioner or “locator”. The locator is located next to the actual pliers head plane and in front of or behind the die halves. An end region of the workpiece protruding from the pliers head in the area of the locator can come to rest against a stop formed by the locator, allowing to set the axial position of the workpiece in the die halves. Furthermore, the end region is accommodated with a form-fit in a recess of the locator. It is possible that the locator comprises only one such recess. In order to then be able to use this recess for the different die halves arranged next to each other, the locator can comprise a degree of freedom of displacement that allows the accommodation to be arranged behind the pair of die halves to be used. Alternatively, EP 2 463 969 B1 proposes that the locator is embodied as a revolver which is rotatable about a rotational axis which is oriented vertically to the pliers plane in which the pliers jaw and the hand levers are moved. In this case, the flat end face of the revolver associated with the pliers head comprises several accommodations having different geometries. In the different rotational positions of the revolver, the end region of the workpiece can enter one of the accommodations of the revolver in each case.

EP 3 984 702 A1 corresponding to U.S. Pat. No. 12,057,672 B2 discloses crimping pliers wherein two die halves units are held on pliers jaws. The die half units each have ribbed die halves that can be moved into one another in the direction of a crimping axis. The die halves are held on a bearing body of the die half unit so that they can be rotated around the crimping axis. Depending on the rotation of the die half around the crimping axis, the workpiece can be inserted into the accommodation formed by the die halves in different orientations relative to the head of the pliers and the workpiece can be crimped in these different orientations.

U.S. Pat. No. 3,094,702 A discloses crimping pliers. By use of these crimping pliers two axial sections of a plug can be processed by two pairs of die halves arranged next to each other and having different die halves contours, in particular to provide a conductor crimp on the one hand and an insulation crimp on the other hand. The two pairs of die halves are guided together in a guide groove of a fixed pliers part along parallel crimping axes. The crimping movement of the pairs of die halves is brought about by the fact that the die halves are each supported at their ends on cam surfaces embodied as an inner surface of an actuating ring of the movable pliers part. A pivoting of the movable pliers part relative to the fixed pliers part leads to a relative rotation of the actuating ring and thus to a sliding movement of the die halves along the cam surfaces. In this way, the pairs of die halves are closed against the bias of return springs and the simultaneous crimping of the two axial sections of the connector takes place. The crimping pliers known from U.S. Pat. No. 3,094,702 A have a locater, which assists the insertion of the connector, as well as a forced locking unit, which blocks the opening movement of the pliers parts during the crimping stroke and only allows the opening movement after the crimping stroke has been completed.

US 2004/0093999 A1 corresponding to U.S. Pat. No. 6,997,028 B2 discloses pliers which can be used to strip the insulation from a cable in the area of a pliers jaw. On the other hand, the pliers can also be used to crimp a connector. For this purpose, a die drum comprising die halves with different die half contours distributed around the circumference is mounted rotatably relative to a fixed part of the pliers. The different die halves can be selectively transferred by the user into a working position by manually rotating the die drum. In the working position a plug can be crimped between the die half, which is in the working position, and a die punch, which is actuated by a movable hand lever. The drive mechanism for the die punch, which interacts with the respective die half transferred to the working position by the user by rotating the die drum, is not described in more detail in US 2004/0093999 A1.

CN 116 237 421 A discloses a machine tool for punching out a battery casing of a lithium-ion battery. The machine tool has a workbench on which a sheet metal to be processed rests on rollers. A tool drum, whose rotational axis is oriented horizontally, has punching tools in a 12 o'clock position, a 3 o'clock position, a 6 o'clock position and a 9 o'clock position. The punching tool arranged in the 12 o'clock position is used to process the sheet metal. After the process of punching out by use of this punching tool, the tool drum is rotated in such a way that the punching tool with the punched-out part of the sheet is moved to the 6 o'clock position, where the punched-out part is able to fall down due to gravity. This removal of the punched-out part from the punching tool is assisted by a cam that actuates the punching tool. The four punching tools distributed around the circumference provide that the machine tool can be operated in cycles.

Further prior art is known from FR 2 217 830 A corresponding to GB 1 453 479 A.

### SUMMARY OF THE INVENTION

The invention proposes a tool comprising two processing bodies. The processing bodies can be formed in one single part or more parts. To name just a few examples that do not limit the invention, the processing bodies can be die halves, die half holders, stripping blades, stripping blade holders, cutting blades or cutting blade holders.

In one embodiment, the proposed tool is multifunctional and in particular
enables simplified operation and/or
eliminates the need to use a large number of different tools for processing different workpieces and/or for different processing steps.

A group of tools comprises two subgroups of these tools, the group being improved in particular with regard to the manufacturing, stocking and component costs.

The processing bodies together form an accommodation for a workpiece. If, for example, the processing bodies are die halves, the processing bodies together form a die by which the workpiece is pressed. The accommodation (into which the workpiece can be inserted and in the area of which the workpiece is pressed) is then formed between the die halves.

The accommodation comprises a longitudinal axis. The workpiece can be inserted into the accommodation in the direction of the longitudinal axis and, after pressing, can be removed from the accommodation in the direction of the longitudinal axis. The longitudinal axis of the accommodation is defined on the one hand by the opening defined by the processing bodies for inserting the workpiece and by the contouring of the processing surfaces of the processing bodies. For the aforementioned example of the die halves, the inner surfaces of the die halves, which are pressed against the workpiece (in particular a plug with a cable arranged therein), define the longitudinal axes.

The two processing bodies can be moved between an open position and a closed position (and vice versa). During the movement from the open position to the closed position, the workpiece is processed. Here, the processing bodies are moved relative to each other along a processing axis via a processing stroke, the processing axis being oriented radially to the longitudinal axis of the accommodation for the workpiece. As a result of this radial orientation, the movement of the processing bodies from the open position to the closed position results in the workpiece being processed between the processing bodies. In the present context, “processing” refers in particular to pressing, crimping, cutting in or cutting through the workpiece.

The processing bodies comprise a common rotational degree of freedom in that the processing bodies can be rotated together about a rotational axis (at least) from a first rotational position to a second rotational position. Here, the axis of rotation is preferably oriented vertically to the tool head plane, movement plane of the hand levers and/or movement plane of the tool jaws of the tool. Alternatively, the rotational axis can be oriented parallel to the longitudinal axis of the accommodation and have a distance from this longitudinal axis.

By means of this rotation about the rotational axis between the rotational positions, the processing axis of the processing bodies can then be specifically transferred from a first relative position to a second relative position and/or from a first orientation to a second orientation. In the different rotary positions different pairs of processing bodies can be activated and actuated by the tool actuation unit.

There are various options for providing the rotatability about the rotational axis and the different rotational positions. For example, it is possible that a type of pivot bearing provides the rotational degree of freedom. It is also possible that the processing bodies (possibly as a component of a tool insert or in a housing of a tool insert) can be inserted into an accommodation of a tool actuation unit in different orientations corresponding to the rotational positions and can be fastened therein (e.g. basically corresponding to the insertion of the plates according to EP 0 468 335 A2 in different orientations into their guide).

There are different options for the alignment of the processing axis, along which the two processing bodies are movable relative to each other. For one option, the processing axis extends parallel to the rotational axis. In this case, a change in position can be brought about by rotating the processing bodies from the first rotational position to the second rotational position.

Preferably, however, the processing axis is oriented radially to the rotational axis. In this case, the rotation of the processing bodies about the rotational axis from the first rotational position to the second rotational position leads to a changed orientation (i.e. a changed angle) of the processing axis.

It is also possible that several pairs of processing bodies can be rotated in common between different rotational positions.

The tool has a rotating body, which is also referred to as a revolver and is preferably embodied as a drum or cylindrical in a first approximation. The revolver can be any rotatable component or a rotatable constructional unit. The revolver can be rotatable about the rotational axis. The revolver comprises at least two pairs of processing bodies. In one embodiment, the pairs of processing bodies comprise processing axes that are oriented in different directions radially to the rotational axis. In this case, the successive transfer of the different pairs of processing bodies into the same position and/or orientation can be achieved by rotating the revolver into different rotational positions, wherein an interaction of an actuating plunger of the tool actuation unit with the respective pair of processing bodies can then be brought about in this position and orientation.

The rotational degree of freedom of the processing bodies and of the revolver can enable rotation in steps or a stepless rotation.

In one embodiment, a fixing device is provided. By means of the fixing device, a rotational position of the processing body or of the revolver, once brought about by the user, can be fixed. This allows to secure a working position of the processing body or the revolver, which can apply to the operation of the tool or can also be advantageous for storing the tool in a toolbox, for example. The fixing device can also support a part of the forces acting between the workpiece and the processing bodies during operation of the tool in order to prevent unintentional rotation of the processing bodies or of the revolver about the rotational axis as a result of these forces.

The fixing device can be designed in a variety of ways. For example, the fixing device can be a screw connection or clamping connection.

In one embodiment, the fixing device is a latching device. In the case of a latching device, latching and/or unlatching is preferably performed by applying sufficient rotational forces to the revolver or the processing bodies secured by the latching device. Preferably, the latching device comprises a latching element which is spring-loaded and engages in a latching recess for latching. An inclination of a contact surface between the latching element and the latching recess, a preload of the spring acting on the latching element and/or the stiffness of the latching spring can be used to set the rotational force at which the latching unit is released.

However, it is also possible that the fixing device is a locking device. Such a locking device preferably makes it impossible to release the locking device simply by applying rotational forces to the revolver or by the processing forces. Rather, a movement of a separate locking element is absolutely necessary for unlocking the locking device, which must be brought about by a separate manual actuation of the locking element.

Combined latching and locking devices are also possible, in which the construction elements are latched to each other in one direction of movement, while they are locked to each other in the other direction of movement.

The tool comprises a tool insert and a tool actuation unit. The tool insert then comprises the revolver with at least two pairs of processing bodies. The tool actuation unit comprises an actuating plunger. The tool actuation unit can move and generate the actuating force of the actuating plunger in a variety of different ways. For example, the tool actuation unit can have hand levers to which a user can apply hand forces, which are then converted with a gear-up ratio or reduction ratio (using a suitable transmission mechanism) to an actuating force which actuates the actuating plunger. However, it is also possible that an actuating force of the actuating plunger is brought about by means of an electric, pneumatic or hydraulic actuator.

The tool actuating unit comprises an accommodation which is preferably arranged in the area of a fixed or movable tool jaw or a tool head. The tool insert can then be inserted (permanently or replaceably and/or directly) into this accommodation. To name just a few examples, the revolver can be inserted directly into the accommodation and can be rotatably mounted with an outer surface to an inner surface of the accommodation or with an inner surface on a bearing journal of the accommodation. However, it is also possible that the tool insert comprises a housing in which the revolver is rotatably mounted. In this case, the housing is then inserted into the accommodation. The housing can then be permanently or interchangeably connected to a tool jaw of the tool actuation unit.

An actuating force is transmitted between the tool actuating unit and the tool insert via a contact between an actuating surface of the actuating plunger and an actuating surface of one of the processing bodies of the pairs of processing bodies which is activated in the selected rotational position and which is preferably the moving processing body of the pair of processing bodies. If the revolver is in a first rotational position, the first pair of processing bodies establishes the contact with the actuating surface of the actuating plunger. If the revolver is rotated to the second rotational position, the processing surface of the first pair of processing bodies is moved away from the actuating surface of the actuating plunger and a corresponding actuating surface of a second pair of processing bodies is brought into operative connection with the actuating surface of the actuating plunger. The actuating surfaces can lie loosely against each other, which makes it possible to bring about the rotary movement of the revolver. Without generating an actuating force by the tool actuation unit, a preload of a spring can ensure a base contact pressure force between the actuating surfaces. However, it is also possible that the actuating surfaces are separated from each other by a gap when there is no actuating force of the tool actuation unit.

There is a wide range of possibilities for the basic design of the tool actuation unit, whereby all the different types of tool actuation units known from the prior art can be used.

For one proposal, the tool actuating unit is a crimping machine actuating unit, so that the rotation of at least one pair of the processing bodies can be used for a stationary crimping machine.

For another proposal, the tool actuation unit is a manual pliers actuation unit comprising, in particular, hand levers via which manual actuation of the tool is possible. For example, the tool is then embodied as crimping pliers which, depending on the configuration of the processing bodies, can crimp different workpieces in the different rotational positions and/or can provide further processing operations (in particular cutting through and/or cutting for stripping).

There are preferably the following options for designing the tool actuation unit as a manual pliers actuation unit:

For a first embodiment, the manual pliers actuation unit has a base body which forms the hand levers and the actuating plunger in one piece. A movement of the hand levers to bring about the actuating stroke and the conversion of the movement of the hand levers to a movement of the actuating plunger requires for conventional hand pliers actuating units that several components (in particular bars or levers) are connected to each other by means of swivel joints to form a transmission mechanism, which is disadvantageous in terms of size, construction effort, component diversity and assembly. For the one-piece design of the base body the relative movement of at least one hand lever with respect to the actuating plunger over the processing stroke is provided by an inherent elasticity of the base body and thus a deformation of the base body. While the design of the components of the aforementioned hand pliers actuating units of the prior art is as rigid as possible with the use of swivel joints, elastic components, in this case an elastic base body, can also be used specifically for this proposal, which makes it possible to use elastic materials. It is possible, for example, that the base body is manufactured from a plastic material, in particular in an injection molding process or in an additive manufacturing process, wherein the plastic can also be fiber-reinforced. Other materials that can be used are biogenic materials, growing raw materials, compostable materials and/or recyclable materials. To give merely one non-limiting example, such a hand pliers actuating unit may be embodied as shown and described in DE 20 2023 000 293 U1. Preferably, the hand pliers actuation unit does not have any pivot bearing.

For a second embodiment, the hand pliers actuation unit comprises a fixed tool part with a fixed tool jaw and a fixed hand lever. Furthermore, the hand pliers actuation unit comprises a movable hand lever. The hand pliers actuation unit also comprises a movable tool jaw and a compression lever. In this case, the movable tool jaw is hinged to the fixed tool part via a swivel joint. The movable hand lever is linked to the movable tool jaw via a swivel joint. The compression lever is linked (in one end region) to the fixed tool part via a swivel joint and (in the other end region) to the movable hand lever via a swivel joint. In the hand pliers actuation unit, a toggle lever drive is formed by the compression lever forming a first toggle lever and a section of the movable hand lever forming the second toggle lever. The swivel joint, with which the pressure lever is linked to the movable hand lever, forms the toggle joint in the toggle lever drive. For this embodiment, one tool jaw (in particular the movable tool jaw [or the fixed tool jaw]) forms the accommodation for the tool insert. The other tool jaw (the fixed tool jaw [or the movable tool jaw]) then comprises or supports the actuating plunger. Thus, the proposed measures with the provision of the rotational degree of freedom of the processing bodies can be integrated in basic known manual pliers actuation units or pressing or crimping pliers that have a toggle lever drive, as explained above. For example, integration into crimping or pressing pliers as described in DE 198 022 87 C1 is possible.

For a third embodiment, the hand pliers actuation unit has a fixed tool part comprising a C-shaped tool head and a fixed hand lever. In this case, the C-shaped tool head forms the fixed tool jaw. The hand pliers actuation unit also has a slide that is guided on the tool head so that it can be moved in translation and forms a movable tool jaw. The hand pliers actuation unit also comprises a compression lever and a movable hand lever. In the hand pliers actuation unit, the compression lever is linked (in one end region) to the fixed tool part via a swivel joint and (in the other end region) to the movable hand lever via a swivel joint. The movable hand lever is hinged to the slide via a swivel joint. A toggle lever drive is formed by the compression lever forming a first toggle lever, while a section of the movable hand lever forms a second toggle lever. The toggle joint of the toggle lever drive is then formed by the swivel joint by which the compression lever is linked to the movable hand lever. One tool jaw (the movable tool jaw [or the fixed tool jaw]) forms the accommodation for the tool insert or supports it, while the other tool jaw (the fixed tool jaw [or the movable tool jaw]) comprises the actuating plunger or supports it. Thus, for example, the proposed measures can also be integrated into crimping pliers with a drive mechanism as shown and described in principle in DE 198 077 37 C2.

For a fourth embodiment, the manual pliers actuation unit can comprise an O-shaped tool head that forms a fixed tool jaw. A slide is guided for a translational displacement on the tool head. The slide forms a movable tool jaw. Two movable hand levers are linked to each other (similar to a pair of scissors) via a swivel joint. The hand pliers actuation unit has two pulling bars for this fourth embodiment. The pulling bars are each linked in one end region to an associated hand lever via a swivel joint, while in the other end region they are linked to the tool head via a swivel joint. A pivot pin of the swivel joint, via which the two hand levers are linked to each other, is then arranged in an accommodation of the slide. An actuating force generated by the hand levers can then be transmitted to the slide via the contact of the pivot pin with the accommodation of the slide. For this fourth embodiment, for example, the proposed measures can be integrated into a type of crimping pliers as described in the publications DE 100 569 00 C1 and EP 0 468 335 A2.

As mentioned above, a fixed or replaceable connection can be used between the tool insert and an accommodation of the tool actuation unit. In principle, the connection options known from the prior art can be used for an interchangeable assembly of the tool insert with the accommodation of the tool actuation unit. For one embodiment, a tool jaw comprises an open-edged recess. The tool insert then comprises a traverse carrier. In order to support the tool insert on the tool jaw in a replaceable manner, the traverse carrier is arranged in the recess.

Disassembly is then possible by simply removing the tool insert and thus the traverse carrier from the recess. It is possible that additional coupling or connecting measures are used between the tool insert and the accommodation of the tool actuation unit, in particular an additional fixation screw and/or a further support of a second traverse carrier in a second open-edged recess. The interaction of the (at least one) traverse carrier with the (at least one) recess is used to provide a transmission of a force and a support and/or a securing against displacement and/or rotation. A corresponding support between at least one traverse carrier and at least one open-edged recess can also be used to support an actuating plunger or a housing of the tool insert on a tool jaw.

For the embodiments explained above, the tool jaw can have two parallel and spaced-apart tool jaw plates comprising an open-edged recess or preferably two spaced-apart open-edged recesses on the side facing towards the tool or pliers mouth. In this case, the tool insert, the actuating plunger or the housing of the tool insert may comprise a flange which is arranged in the intermediate space between the tool jaw plates and is thus guided and supported between the tool jaw plates. The tool insert, the actuating plunger or the housing of the tool insert can then comprise one or two traverse carriers, via which the additional support and securing against displacement or rotation takes place. Preferably, the interchangeable connection of the tool insert, the actuating plunger or the housing of the tool insert is provided by means of the cross bolts and recesses in the same way as described in DE 198 022 87 C1 (albeit for the support of conventional die halves on tool jaws).

In a group of tools the tools can be embodied as described above. In one embodiment, the group of tools comprises two subgroups, namely a first subgroup of tools and a second subgroup of tools. The tools of the first subgroup and the tools of the second subgroup then comprise different types of tool actuation units. For example, tools of the first subgroup may comprise tool actuating units embodied as crimping machine actuating units, while the tools of the second subgroup may comprise tool actuating units embodied as manual pliers actuating units. It is also possible that the tools of the different subgroups are embodied as different types of hand pliers actuating units. The tools of different subgroups can then be used for different purposes. The tools of the two subgroups comprise the same tool inserts despite of the different designs of the tool actuation units. In this way, the variety of construction parts or components can be reduced, which is advantageous in terms of manufacturing, stocking and provisioning costs.

Advantageous developments of the invention result from the claims, the description and the drawings.

The advantages of features and of combinations of a plurality of features mentioned in the description only serve as examples and may be used alternatively or cumulatively without the necessity of embodiments according to the invention having to obtain these advantages.

The following applies with respect to the disclosure—not the scope of protection—of the original application and the patent: Further features may be taken from the drawings, in particular from the illustrated geometries and the relative dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims which, however, does not apply to the independent claims of the granted patent.

The number of the features mentioned in the claims and in the description is to be understood to cover this exact number and a greater number than the mentioned number without having to explicitly use the adverb “at least”. For example, if a pair of processing bodies is mentioned, this is to be understood such that there is exactly one pair of processing bodies or there are two pairs of processing bodies or more pairs of processing bodies. Additional features may be added to the features of the claims or the features of the claims may be the only features of the respective product.

The reference signs contained in the claims are not limiting the extent of the matter protected by the claims. Their sole function is to make the claims easier to understand.

### BRIEF DESCRIPTION OF THE DRAWINGS

In the following, the invention is further explained and described with reference to preferred embodiments shown in the figures.

FIG. 1 shows a front view of a first embodiment of a tool.

FIG. 2 shows a front view of the tool as shown in FIG. 1 with the cover removed.

FIG. 3 shows the tool according to FIG. 1 to 2 in an exploded view slanted from the front.

FIG. 4 shows the tool according to FIG. 1 to 3 in an exploded view slanted from behind.

FIG. 5 shows a detail of a tool insert of a tool according to FIGS. 1 to 4 in the area of a revolver with several pairs of processing bodies.

FIG. 6 shows a second embodiment of a tool in a front view.

FIG. 7 shows a front view of the tool according to FIG. 6 in a partially disassembled state, the tool being in an open configuration.

FIG. 8 shows the tool according to FIGS. 6 and 7 in a representation corresponding to FIG. 6, but here the tool being in a closed configuration.

FIG. 9 shows the tool according to FIG. 6 to 8 in an exploded view slanted from the front.

FIG. 10 shows a third embodiment of a tool in a front view, the tool being in an open configuration.

FIG. 11 shows a front view of the tool according to FIG. 10 in a partially disassembled state, the tool being in an open configuration.

FIG. 12 shows the tool according to FIGS. 10 and 11 in a representation according to FIG. 10, the tool being in a closed configuration.

FIG. 13 shows the tool according to FIGS. 10 to 12 in a three-dimensional exploded view slanted from the front.

FIG. 14 shows another embodiment of a tool in a front view in an open configuration.

FIG. 15 shows the tool according to FIG. 14 in a front view and a closed configuration.

FIG. 16 shows the tool according to FIGS. 14 and 15 in a three-dimensional view, a tool insert and an actuating plunger insert being disassembled from a tool actuating unit.

FIG. 17 shows three-dimensional individual views and exploded views of the work tool insert and the actuating plunger insert as shown in FIG. 16.

FIG. 18 shows the tool insert and the actuating plunger insert as shown in FIGS. 16 and 17 in a three-dimensional view slanted from behind.

FIG. 19 shows the tool insert and actuating plunger insert as shown in FIGS. 16 to 18 in a three-dimensional view slanted from the front.

FIG. 20 shows the tool insert and the actuating plunger insert according to FIGS. 16 to 19 in a front view in a partially disassembled state.

FIG. 21 shows a further embodiment of a tool in a front view, wherein a tool insert and an actuating plunger insert are disassembled from the tool actuating unit and these are embodied identical to the tool insert and the actuating plunger insert in the embodiment of FIGS. 16 to 20.

FIG. 22 shows a front view of another embodiment of a tool.

FIG. 23 shows a front view of a tool head of the tool according to FIG. 22 in a partially disassembled state.

FIG. 24 shows a three-dimensional view slanted from the front of a tool designed as a crimping machine.

FIG. 25 shows a front view of a guide unit insert of the crimping machine of FIG. 24 and a tool insert and an actuating plunger insert in a state in which they have been disassembled from the guide unit insert.

FIG. 26 shows the tool insert and the actuating plunger insert according to FIG. 25 in a three-dimensional exploded view.

### DETAILED DESCRIPTION

In the following description of the figures, some components and features that correspond or are similar in terms of design and/or function are labelled with the same reference numbers. In this case, the additional letter a, b . . . may be added for differentiation. A reference to these components and features can then be made with or without the use of the additional letter, which can then refer to one component or feature, several components or features or all components or features.

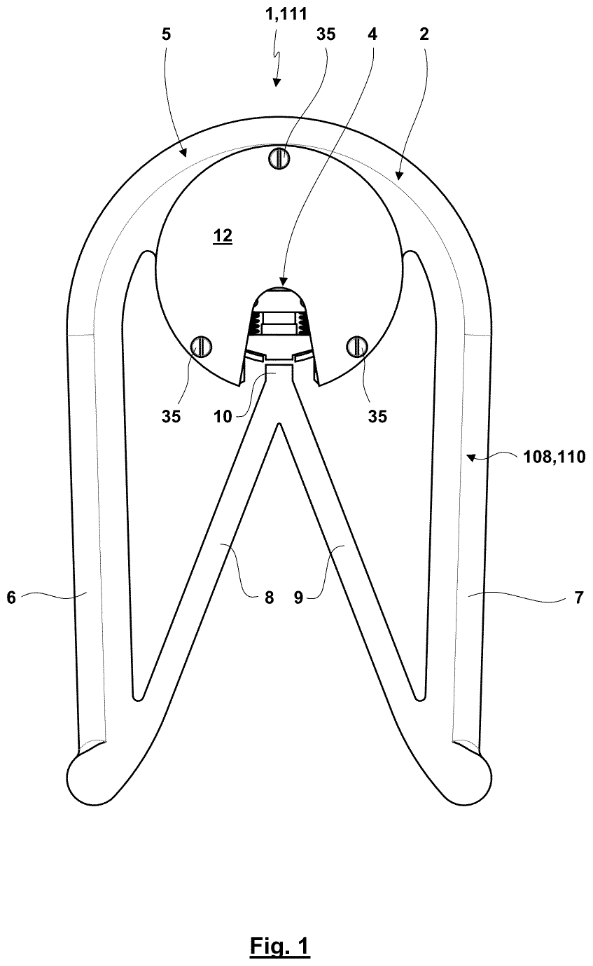

FIG. 1 shows a tool 1 with a base body 2. The base body 2 forms an accommodation 3 for a tool insert 4.

The base body 2 forms a tool head 5, which comprises the accommodation 3. Hand levers 6, 7 extend from the tool head 5, which are oriented approximately parallel to each other for the embodiment shown in FIG. 1 (without this necessarily being the case). In the end region facing away from the tool head 5, compression bars 8, 9 are formed on the hand levers 6, 7, which extend back towards the tool head 5 at an acute angle relative to the associated hand levers 6, 7. The two compression bars 8, 9 run towards each other in a V-shape in the direction of the tool head 5 and are firmly connected to each other in the connecting area of the legs of the V, i.e. in the end sections that are arranged closest to the tool head 5. The connecting area of the compression bars 8, 9 forms an actuating plunger 10. The actuating plunger 10 comprises an actuating surface 11 on the side facing towards the tool head 5 and thus the tool insert 4.

The tool 1 has a cover 12 or lid (in the following cover 12), which is screwed to the base body 2 in the area of the tool head 5 using fixation screws 35. The accommodation 3 forms an interior space between the base body 2 and the cover 12.

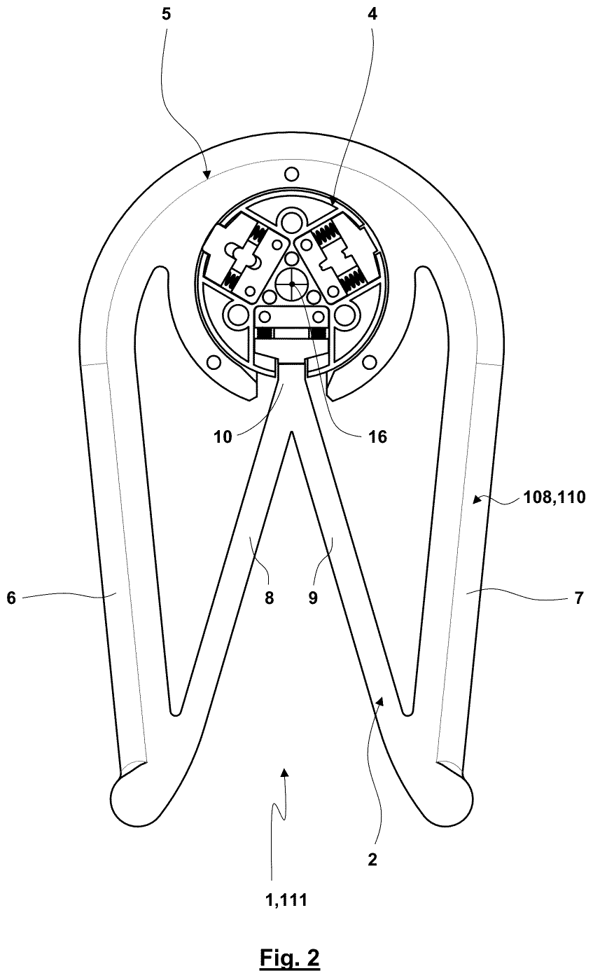

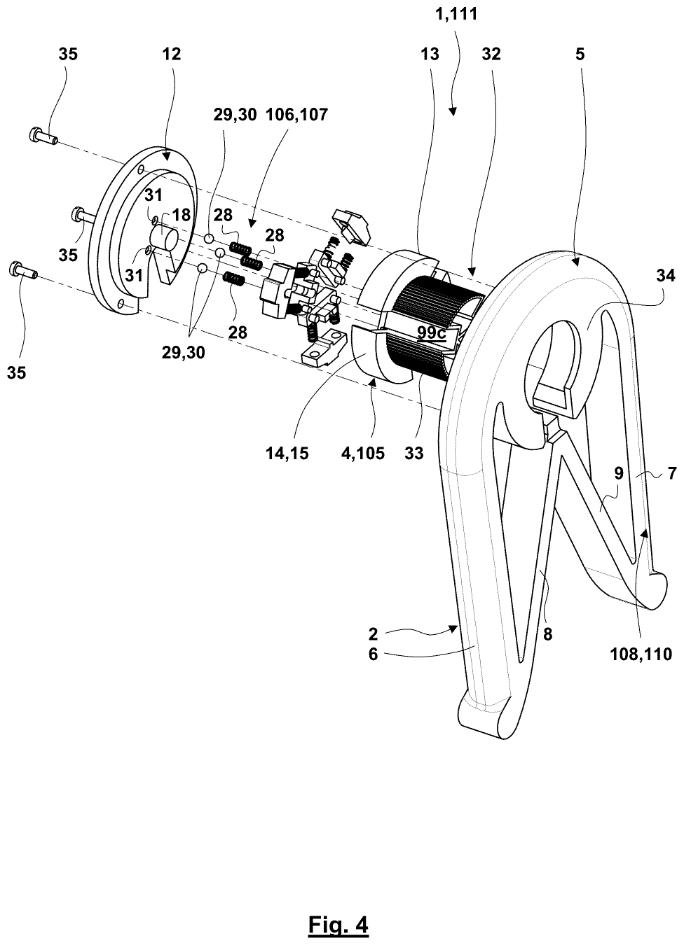

The tool insert 4 is shown with the cover 12 removed in FIG. 2. The tool insert 4 has a revolver housing 13, which is arranged in the interior space delimited by the accommodation 3 and the cover. The revolver housing 13 has a cylindrical outer surface 14, which forms a guide 15, via which the revolver housing 13 is rotatably guided on a corresponding cylindrical inner surface of the tool head 5, which is formed by the accommodation 3, such that the revolver housing 13 is guided for being rotated about a rotational axis 16 relative to the tool head 5. Alternatively or cumulatively, the revolver housing 13 may comprise a bore 17 which forms a guide 15. The guide 15 can then provide a rotation of the revolver housing 13 and thus of the tool insert 4 about the rotational axis 16 in that a pin 18 formed by the cover 12 is guided in the guide 15 (cp. FIG. 4).

In the example shown, the tool insert 4 has three pairs of processing bodies 19a, 20a; 19b, 20b and 19c, 20c.

In the embodiment shown, the processing bodies 19 are embodied as processing bodies that are movable over the processing stroke, while the processing bodies 20 are embodied as processing bodies that are fixed over the processing stroke. The movable processing body 19 is displaceable relative to the fixed processing body 20 along a processing axis 21. The processing bodies 19, 20 are distributed in the circumferential direction around the rotary axis 16 in such a way that they are arranged in a 2 o'clock position, a 6 o'clock position and a 10 o'clock position. The processing axes 21a, 21b, 21c are oriented radially to the rotational axis 16 and have orientations offset by 120° in the circumferential direction. The movement of the movable processing bodies 19 leads to a loading of at least one spring 22, 23.

The fixed processing body 20 is permanently mounted on the revolver housing 13 or formed by the same. The movable processing body 19 is guided in the direction of the processing axis 21 via a guide provided by the revolver housing 13. For the illustrated embodiment, the guides for the movable processing body 19 are embodied as ribs of the revolver housing 13.

On the side facing away from the fixed processing body 20, the movable processing bodies 19 have a protrusion 24 that forms an actuating surface 25, which is intended for interaction with the actuating surface 11 of the actuating plunger 10. For this purpose, the revolver housing 13 has an opening 26 in the guide 15 through which the actuating plunger 10 and/or the protrusion 24 extend. The revolver housing 13 has blind bores 27 arranged parallel to the rotational axis 16 and distributed in the circumferential direction around the rotational axis and located radially inwards of the processing bodies 20.

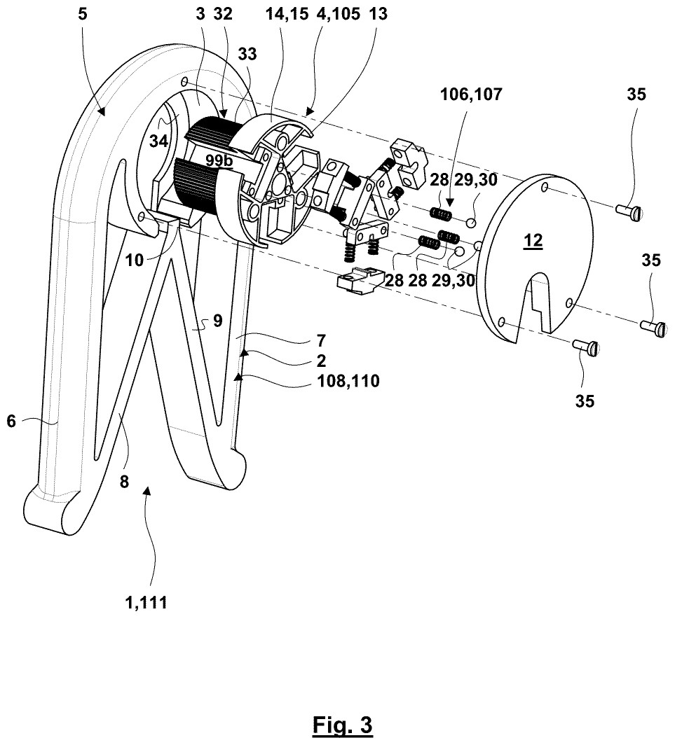

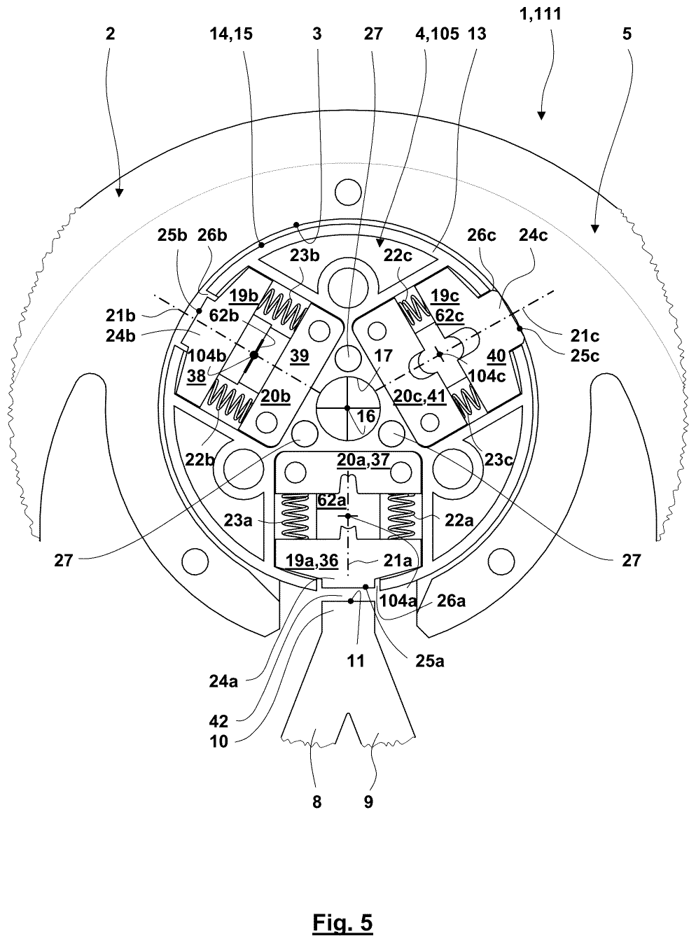

As can be seen in particular in FIG. 3, latching springs 28 are inserted into the blind bores 27, so that these are supported with one spring base on the bottom of the blind bore 27. The other spring base of the latching springs 28 biases latching elements 29, which are embodied as latching spheres 30. In a first, second and third rotational position of the revolver housing 13, the latching elements 29 latch in latching recesses 31 of the cover 12 (which may be embodied as blind bores). Here, in the first rotational position (which is shown in FIG. 5) the pair of processing bodies 19a, 20a is aligned with the processing axis 21a in such a way that the protrusion 24a of the processing body 19a can interact with the actuating plunger 10 of the base body 2. In the second rotational position, the pair of processing bodies 19b, 20b can then be brought into interaction with the actuating plunger 10, while correspondingly in the third rotational position, the pair of processing bodies 19c, 20c can be brought into interaction with the actuating plunger 10.

For the embodiment example shown, the revolver housing 13 is roughly mushroom-shaped, with a mushroom head of the revolver housing 13 forming the outer surface 14 with the guide 15 and the processing bodies 19, 20 with the springs 22, 23 and the protrusion 24 being arranged within the mushroom head. The mushroom stem of the revolver housing 13 forms an actuating extension 32, which is basically cylindrical here. The actuating protrusion 32 extends out of the accommodation 13 and of the base body 2 on the side facing away from the cover 12. The actuating extension 32 comprises a knurling 33. The user can rotate the actuating extension 32 in the area of the knurling 33 by means of the fingers, which allows the user to change the rotational positions. The user receives haptic feedback when the latching elements 29 engage in the latching recesses 31. The mushroom head of the revolver housing 13 is axially trapped between the cover 12 on the one hand and a bottom 34 formed by the base body 2 on the other hand.

FIG. 5 shows that the pairs of processing bodies 19, 20 are designed for different types of processings. In a first pair, for example, the processing bodies 19a, 20a are embodied as die halves 36, 37, which can be used to crimp a connector to a cable. The processing bodies 19b, 20b of a second pair each have cutting blades 38, 39 comprising straight cutting edges, which can be used to cut through a workpiece or cable. The processing bodies 19c, 20c of a third pair each have a cutting blades 40, 41, the cutting edges of which are embodied as approximately semicircular and which are used to cut into the insulation sheath of a cable for stripping.

The tool 1 is operated as shown in FIGS. 1 to 5 as follows:

Initially, a pair of processing bodies 19a, 20a is located in the area of the opening 26, whereby the processing axis 21a of these processing bodies 19a, 20a is oriented coaxially to the actuating axis of the actuating plunger 10. Initially, the actuating surface 11 of the actuating plunger 10 forms a gap 42 with the actuating surface 25a of the protrusion 24a of the processing body 19a. If the user then applies manual forces to the hand levers 6, 7 in such a way that an elastic deformation of the base body 2 occurs in such a way that the end regions of the hand levers 6, 7 facing away from the tool head 5 are moved towards each other, this leads to a movement of the actuating plunger 10 in the direction of the processing axis 21a. As a result of this movement, the gap 42 is closed and the actuating plunger 10 comes to rest with the actuating surface 11 against the actuating surface 25a of the protrusion 24a of the processing body 19a. A further increase in the forces applied by the hand to the hand levers 6, 7 results in an actuating force being applied to the processing body 19a by the actuating plunger 10 via the actuating surfaces 11, 25a. This actuating force in turn causes the processing body 19a to be moved in the direction of the processing body 20a, which causes the processing of the workpiece. Once processing is complete, the forces exerted by the hand on the hand levers 6, 7 are removed, whereby the processing bodies 19a, 20a are moved apart again as a result of the action of the springs 22a, 23a and the actuating plunger 10 is moved away from the tool head 5 in the direction of the processing axis 31 and the gap 42 is reestablished. Further workpieces can then be successively processed in a corresponding manner using the processing bodies 19a, 20a.

If, on the other hand, a workpiece needs to be cut through, the tool insert 4 is rotated in such a way that the protrusion 24b of the processing body 19b is arranged in the effective area of the actuating plunger 10, which can be achieved for the shown embodiment by rotating it counterclockwise by 120° in FIG. 5. If the hand levers 6, 7 are now actuated manually, a workpiece can be cut through between the cutting blades 38, 39 of the processing bodies 19b, 20b.

If a cable is to be stripped, the revolver housing 13 is rotated again so that the protrusion 24c of the processing body 19c is arranged in the effective area of the actuating plunger 10, which can be brought about by rotating it 240° counterclockwise from the rotational position shown in FIG. 5. The incision stroke for cutting the cutting blades 40, 41 into the insulation sheath of the cable can then also be brought about by actuating the hand levers 6, 7 and transmitting an actuating force generated in this way from the actuating plunger 10 via the actuating surfaces 11, 25c to the processing body 19c.

It is possible, for example, that in the different rotational positions of the tool insert 4, the cable is first cut to the desired length by means of the processing bodies 19b, 20b in FIG. 5, then an end region of the conductor is stripped by means of the processing bodies 19c, 20c and finally a connector is crimped to the cable with the stripped end region by means of the processing bodies 19a, 20a.

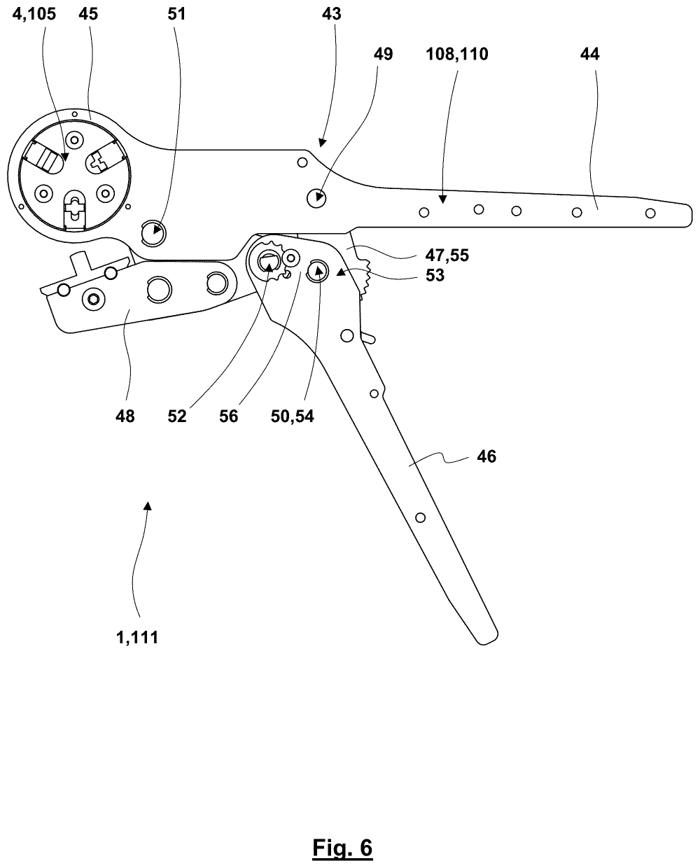

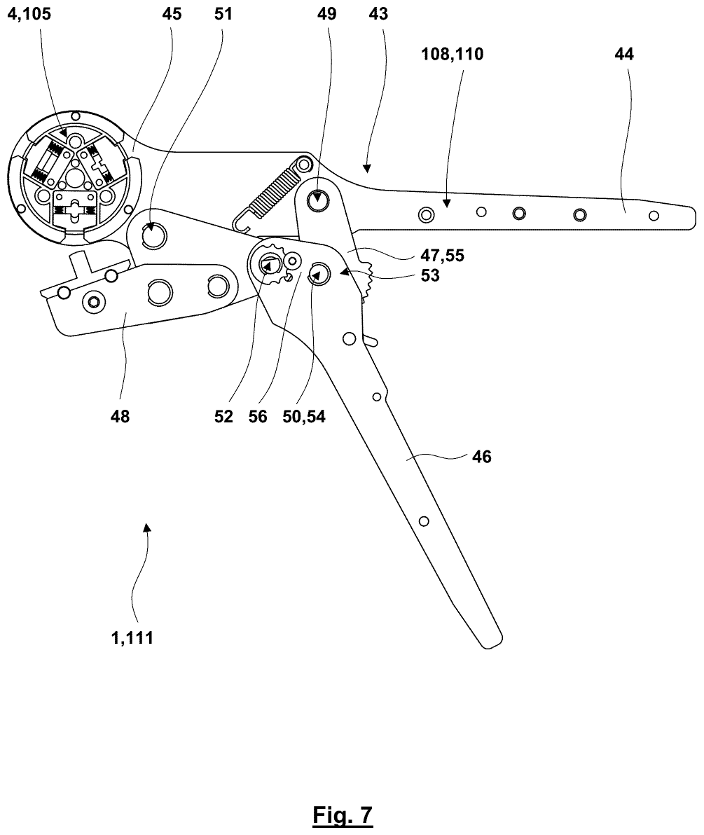

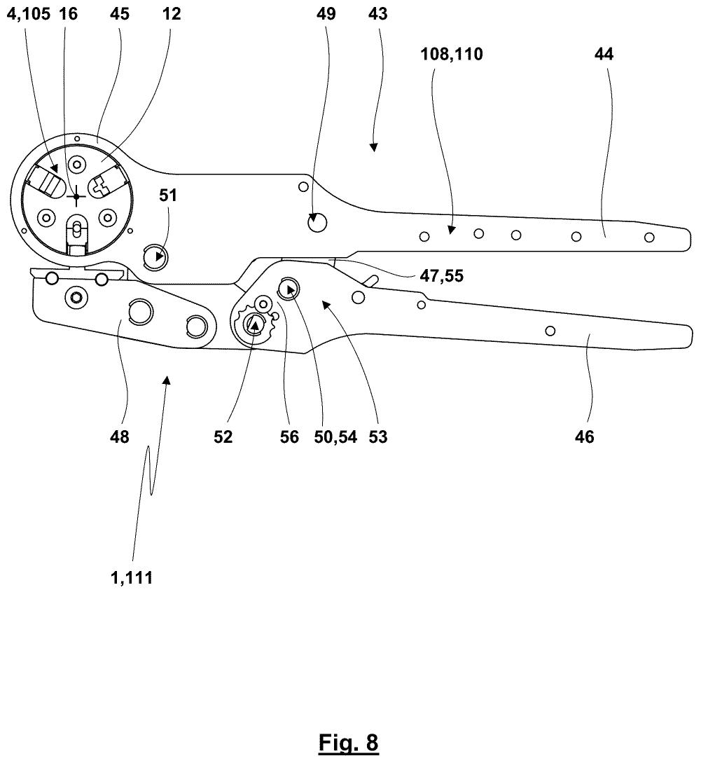

FIGS. 6 to 9 show another embodiment of a tool 1. The tool 1 comprises a fixed tool part 43, which forms a fixed hand lever 44 and a fixed tool jaw 45. The tool 1 also comprises a movable hand lever 46, a compression lever 47 and a movable tool jaw 48.

The compression lever 47 is linked in one end region in a swivel joint 49 to the fixed tool part 43. In the other end region, the compression lever 47 is linked to the movable hand lever 46 via a swivel joint 50. In the area of the fixed tool jaw 45, the fixed tool part 43 is linked to the movable tool jaw 48 via a swivel joint 51. The movable hand lever 46 is linked to the movable tool jaw 48 via a swivel joint 52. The tool 1 comprises a toggle lever drive 53. In the toggle lever drive 53, the swivel joint 50 forms the toggle joint 54. A first toggle lever 55 is formed by the compression lever 47 in the section between the swivel joints 49, 50. A second toggle lever 56 is formed by the movable hand lever 46 in the section between the swivel joints 50, 52. Crimping pliers with drive kinematics of this type and with a toggle lever drive 53 are in principle known from DE 198 02 287 C1.

The fixed tool jaw 45 forms an accommodation 3 for a tool insert 4. The fixed tool part 43 comprises two parallel and spaced tool part plates 57, 58. The movable tool jaw 48, the movable hand lever 46 and the compression lever 47 are arranged and guided between the tool part plates 57, 58. The tool part plates 57, 58 each have a bearing lug 59, 60 to form the accommodation 3. For the time being, the tool insert 4 is embodied as explained for FIGS. 1 to 5. However, here the cover 12 is not attached to the fixed tool jaw 45, but to the revolver housing 13, so that the cover 12 is rotated with the revolver housing 13 about the rotational axis 16 between the rotational positions. The cover 12 has three groove-shaped continuous recesses 61a, 61b, 61c extending from the outer surface and extending radially inwards, which are arranged in alignment with an associated pair of processing bodies 19, 20 when the cover 12 is mounted on the revolver housing 13. Accordingly, the accommodation 62 formed by the pair of processing bodies 19, 20, into which the workpiece can be inserted, is accessible.

The outer surface of the cover 12 having the shape of a segment of a cylinder forms a guide 15 for guiding the rotation of the tool insert 4 about the rotational axis 16. The cylindrical and segment-shaped outer surface parts of the cover 12 forming the guide 15 are accommodated with a precise fitting in the bearing lug 59. In a corresponding manner, the revolver housing 13 can be guided with a shoulder or a guide surface in the bearing lug 60.

The tool insert 4 is axially secured between the tool part plates 57, 58 which is due to the fact that the revolver housing 13 is axially trapped between the limitations of the bearing lugs 59, 60.

For the embodiment example shown, the outer surface of the fixed tool jaw 45 is formed on the one hand by the outer surface of the tool part plates 57, 58 in the area of the bearing lugs 59, 60 and between these by the outer surface of the revolver housing 13.

For the embodiment according to FIGS. 6 to 9, the actuating plunger 10 is not an integral part of the movable tool jaw 48, but is embodied as a separate and detachable as well as interchangeable part of the movable hand lever 46. An actuating plunger insert 63 integrally forms the actuating plunger 10 and a flange 46 forming a base of the actuating plunger 10. Two pin-like traverse carriers 65a, 65b, which are oriented parallel to each other, extend from the flange 46 on both sides. While it is possible in principle that the traverse carriers 65 are embodied as one integral piece of the actuating plunger insert 63, they are preferably bolts which are inserted or pressed into bores in the flange 24. Furthermore, the flange 46 has a bore 66.

On the upper side of the two parallel tool jaw plates 67a, 67b facing towards the fixed tool jaw 45, the movable tool jaw 48 has edge-open recesses 68a, 68b, the distance of the edge-open recesses 68a, 68b corresponding to the distance between the traverse carriers 65a, 65b.

To mount the actuating plunger insert 63 to the movable tool jaw 48, the flange 64 is inserted between the tool jaw plates 67a, 67b. The traverse carriers 65 come to rest against the recesses 68 of the tool jaw plates 67, whereby the actuating plunger insert 63 is supported by the actuating force via the traverse carriers 65 against the recesses 68 of the tool jaw plates 67. The support of the traverse carriers 65 in the recesses 68 also ensures the desired orientation of the actuating plunger insert 63 and thus of the actuating plunger 10. The actuating plunger insert 63 can be additionally secured to the movable tool jaw 48 by screwing the movable tool jaw 48 to the actuating plunger insert 63 by means of a fixation screw 69, which extends through the bore 66 of the flange 64. Preferably, the bore 66 is oversized relative to the fixation screw 69, so that the position of the actuating plunger insert 63 relative to the movable tool jaw 48 is not defined by the fixation screw 69, but by the transverse supports 65.

During operation of the tool 1, the actuating plunger 10 extends between the limitations of the bearing lugs 59, 60 through the opening 26 of the revolver housing 13 into the interior of the tool insert 4, where the actuating plunger 10 then interacts with its actuating surface 11 with the corresponding actuating surface 25 of the respective processing body 20 in the manner described. In principle, the support of the actuating plunger insert 63 via traverse carriers 65 on recesses 68 of a tool jaw 48 corresponds to the connection described in DE 198 02 287 C1. With regard to further details in this regard, reference is made to this publication.

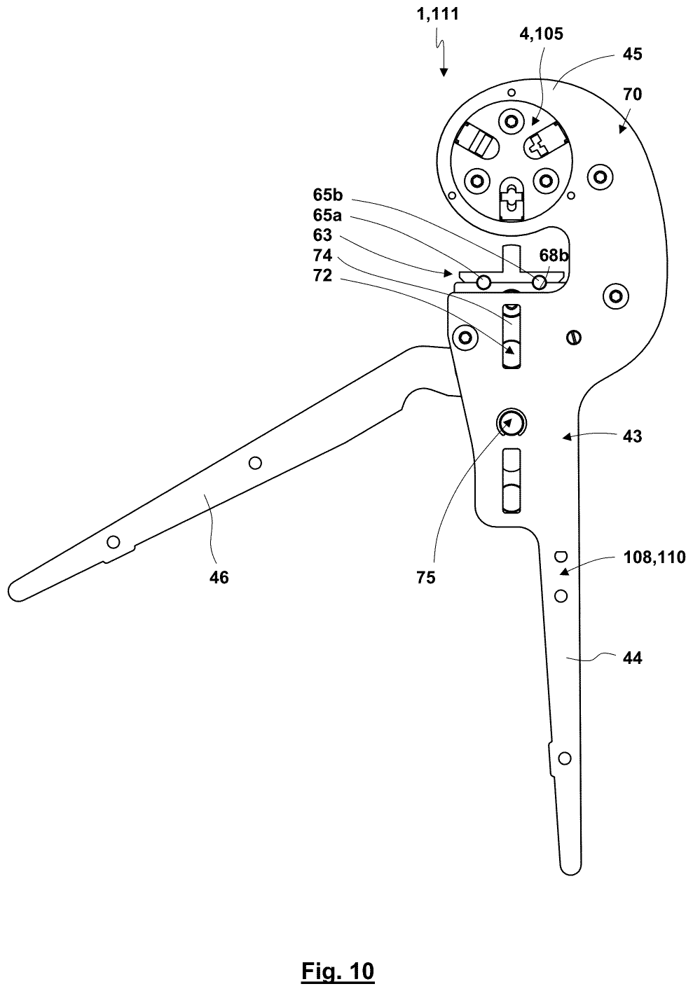

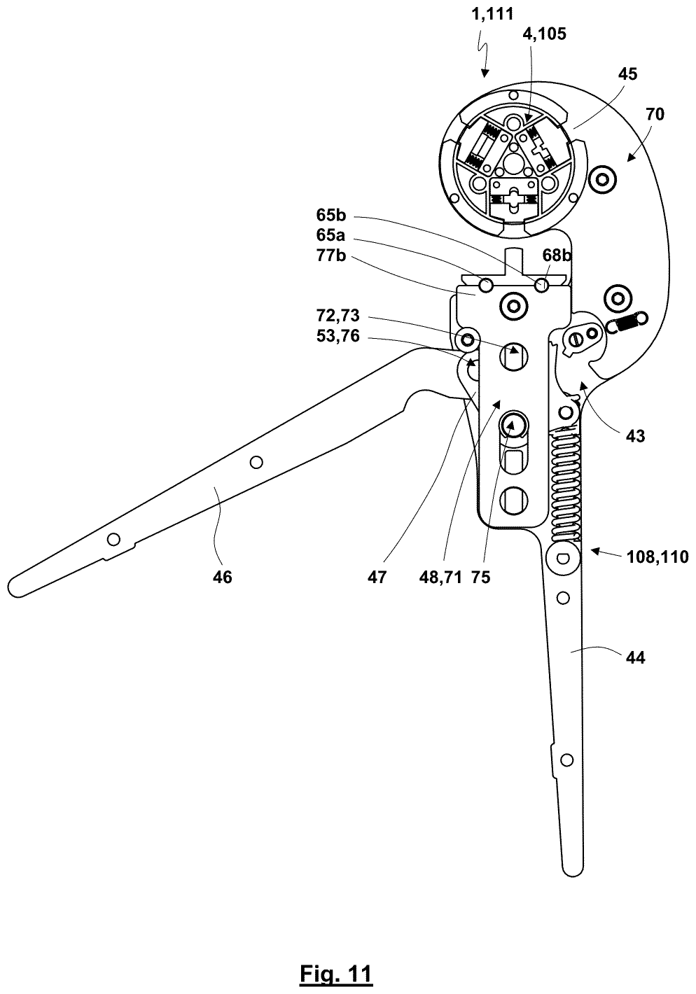

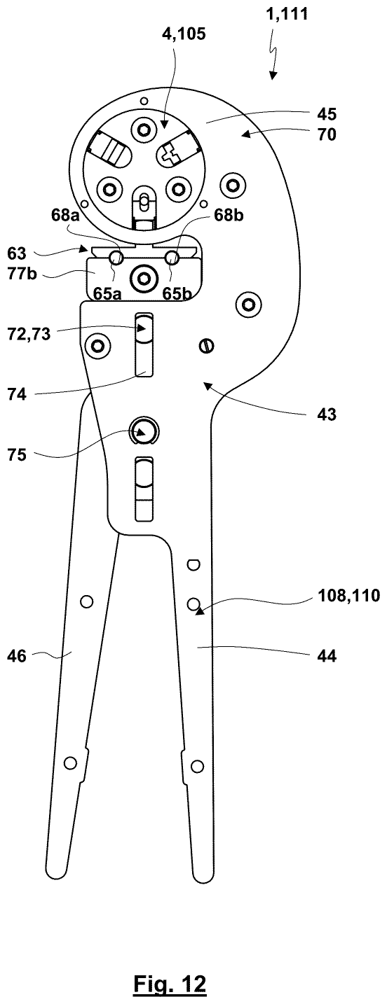

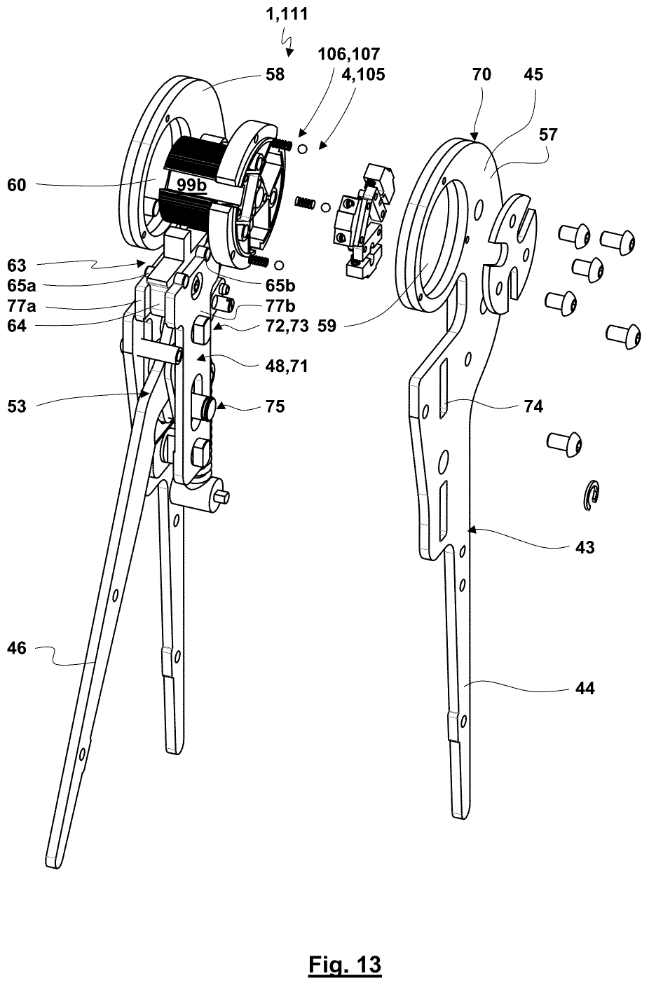

FIGS. 10 to 13 show another type of tool 1 being crimping pliers 111:

In this case, the fixed tool part 43 with the fixed tool jaw 45 and the fixed hand lever 44 forms a C-shaped tool head 70. For this embodiment, a slide 71 is translationally guided on the fixed tool part 43. The slide 71 forms the movable tool jaw 48. In this case, the movable hand lever 43 is linked to the slide 71 in the end region facing towards the tool head 70 by means of a swivel joint 72. Here, a swivel pin 73 of the swivel joint 72 can be guided in an elongated hole 74 of the fixed tool part 43 to ensure the translational degree of freedom of movement. A pressure lever 74 is linked in a swivel joint 75 to the fixed tool part 43 and in a swivel joint 76 to the movable hand lever 46. A toggle lever drive 54 is formed in this way in a corresponding manner as described for the previous embodiment.

For further information on the basic design of a tool 1 of this type, reference is made by way of example to EP 2 096 725 B1 or crimping pliers marketed by the applicant under the label “CS30”.

Also for this embodiment, the fixed tool part 43 also has two tool part plates 57, 58 and bearing lugs 59, 60, in which the tool insert 4 is arranged. In this regard, reference is made to the description of the embodiment described in FIGS. 6 to 9.

Here too, the tool 1 has an interchangeable actuating plunger insert 63, which is embodied as explained above. The traverse carriers 65 of the actuating plunger insert 63 are supported here on recesses 68, which are formed by the two slide plates 76a, 76b of the slide 71.

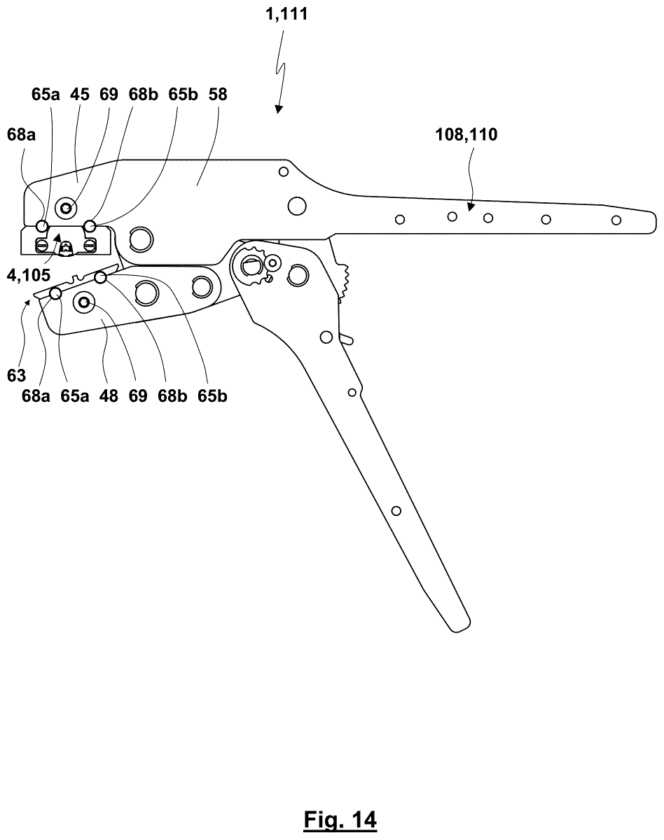

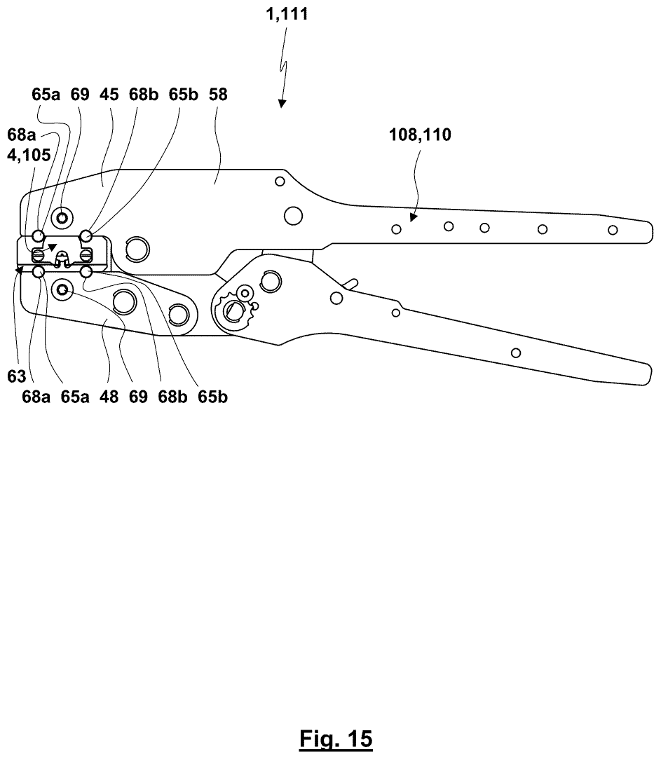

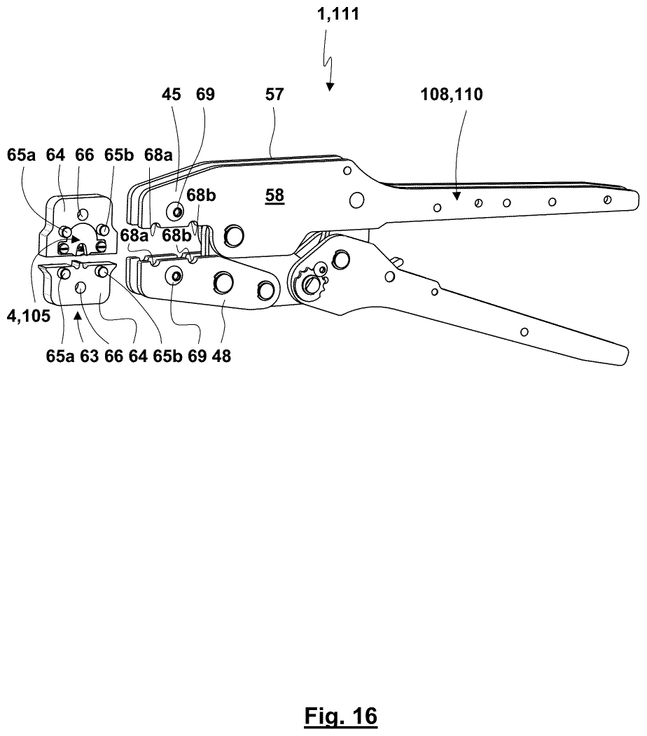

FIGS. 14 to 16 show a tool 1 embodied as crimping pliers 111, in which the basic structure of the drive mechanism corresponds to the embodiment shown in FIGS. 6 to 9. In this case, the tool 1 has both a tool insert 4, which is replaceably mounted on the fixed tool jaw 45, and an actuating plunger insert 63, which is replaceably mounted on the movable tool jaw 48. Both the movable tool jaw 48 and the fixed tool jaw 45 have parallel plates with recesses 68a, 68b. Correspondingly, both the actuating plunger insert 63 as well as the tool insert 4 have transverse supports 65, a bore 66 and a flange 64.

In this way, the tool insert 4 can enter with its flange 64 between the tool part plates 57, 58 and the tool insert 4 can be supported by the traverse carriers 65 in the recesses 68 of the tool part plates 57, 58. Additional securing is then provided by the fixation screw 69, which extends through the bore 66 of the tool insert 4.

The actuating plunger insert 63 is supported on the movable tool jaw 48, which is due to the fact that the flange 64 is arranged between the plates of the movable tool jaw 48. The traverse carriers 65 of the actuating plunger insert 63 are supported in the recesses 68 of the plates. Here, too, additional securing is provided by a fixation screw 69, which extends through the bore 66 of the actuating plunger insert 63.

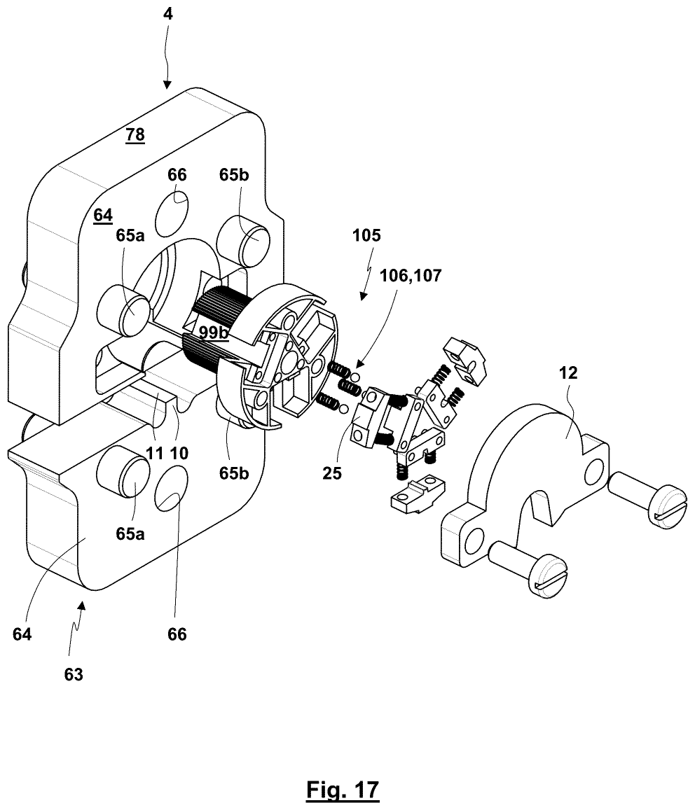

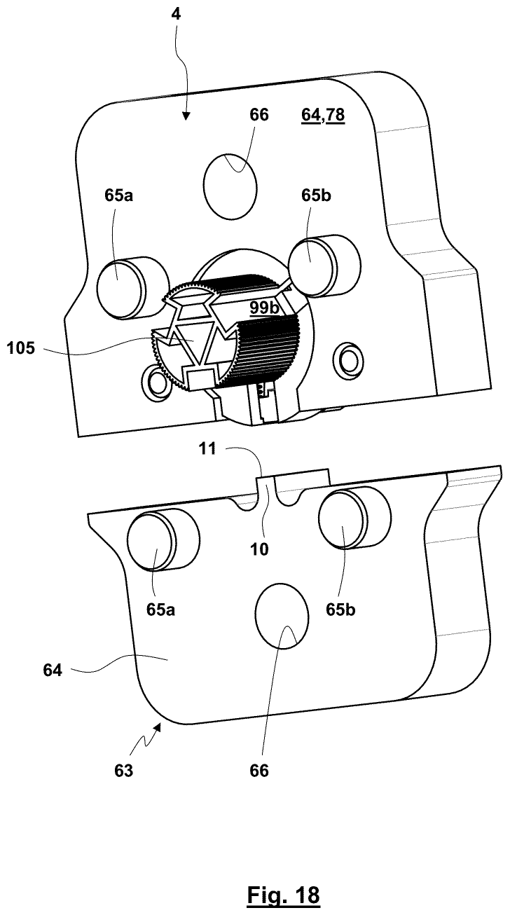

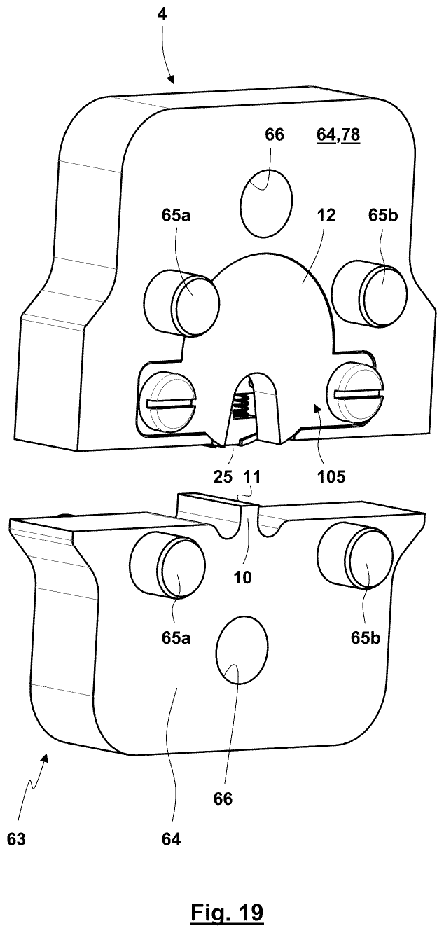

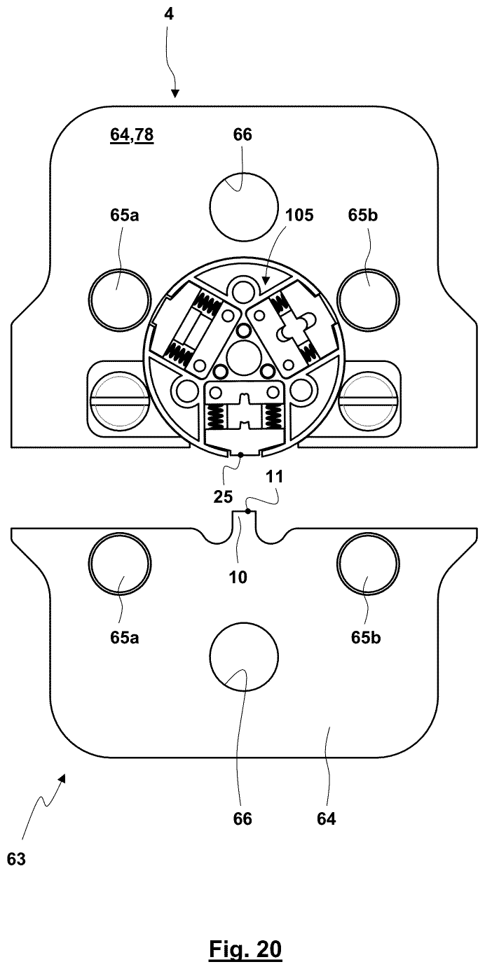

FIGS. 17 to 20 show the tool insert 4 and the actuating plunger insert 63 as individual parts. For this embodiment, the tool insert 4 is not inserted directly into an accommodation 3 formed by the fixed tool jaw 45. Rather, the tool insert 4 has a housing 78 in which the revolver housing 13 is rotatably mounted. The housing 78 comprises the traverse carriers 65, the flange 64 and the bore 66, so that the previously described support via the traverse carriers 65 in recesses 68 of the fixed tool jaw 45 is provided. The cover 12 of the tool insert 4 is then screwed to the housing 78. The above applies to the basic design of the tool insert 4 and the actuating plunger insert 63 and their assembly to the tool jaws 45, 48. The cover 12 is arranged in a correspondingly shaped recess of the housing 78 so that the outer surface of the cover 12 is flush with the flange 64 in order to enable the housing 78 to be inserted between the tool part plates 57, 58 up to the area of the cover 12.

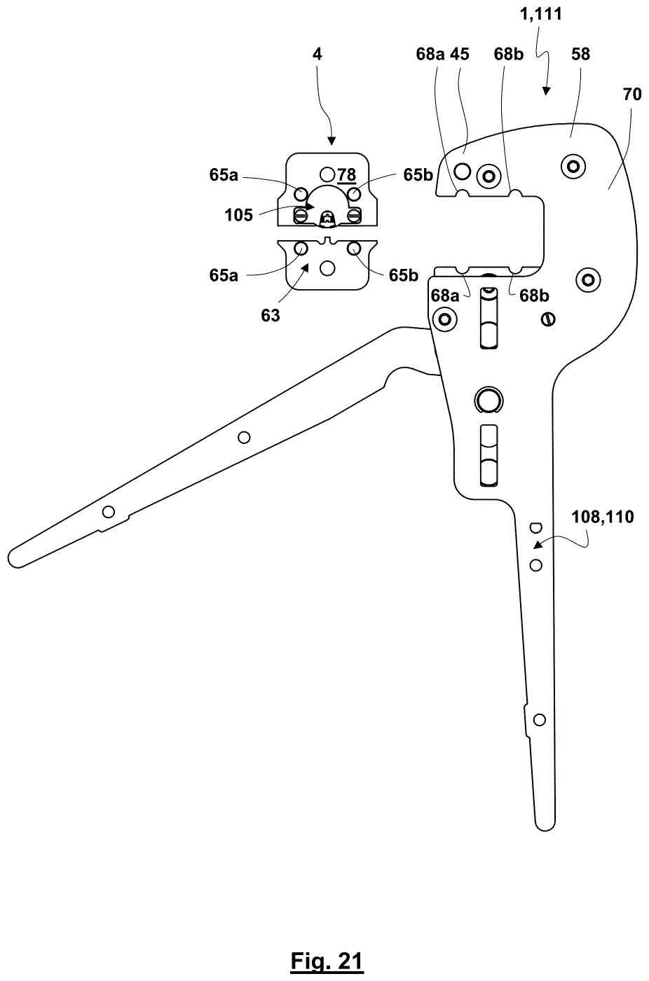

FIG. 21 shows a tool 1 embodied as a crimping pliers 111, the tool comprising a C-shaped tool head 70 and being generally designed as the embodiment in FIGS. 10 to 13. However, here the tool insert 4 is not mounted in bearing lugs 59, 60 of the fixed tool jaw 45. Rather, for this embodiment, the fixed tool jaw 45 comprises recesses 68 in the area of the tool part plates 57, 58. The traverse carriers 65 of the housing 78 of the tool insert 4 can then be supported in the recesses 68. In this embodiment, both an interchangeable actuating plunger insert 63 and an interchangeable tool insert 4 with a support by traverse carriers 65 are used. It is possible that the actuating plunger insert 63 and the tool insert 4 have designs being identical to that of the tool insert 4 and the actuating plunger insert 63 of the tool 1 described in FIGS. 14 to 20, so that they can be used multifunctionally for different types of tools 1.

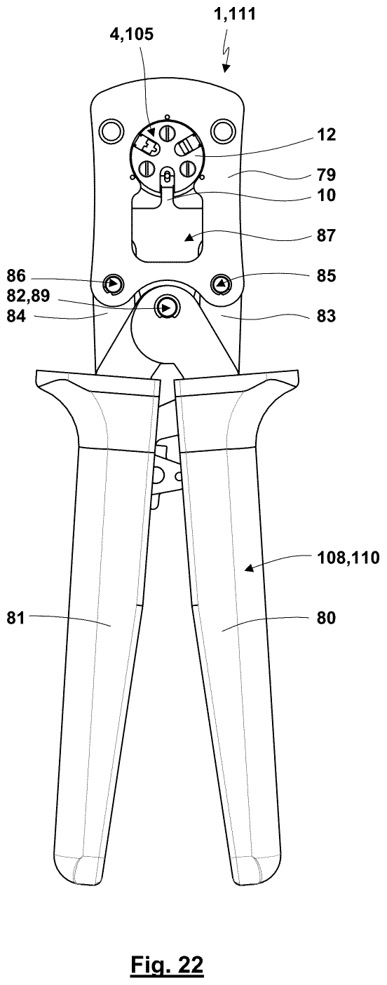

FIG. 22 shows a further embodiment of the tool 1 embodied as crimping pliers 111. In this case, the tool 1 has an O-shaped tool head 79, which comprises two parallel, spaced-apart tool head plates. In this case, the tool 1 has two movable hand levers 80, 81. The end regions of the hand levers 80, 81 facing towards the tool head 79 are directly linked to one another via a swivel joint 82. Furthermore, pulling bars 83, 84 are linked to the hand levers 80, 81 via swivel joints not shown in FIG. 22. The pulling bars 83, 84 are linked to the tool head 79 via swivel joints 85, 86. A slide 87 is guided for a translational movement on the tool head 79. In the embodiment shown, the slide 87 integrally forms the actuating plunger 10. On the side facing towards the hand levers 80, 81, the slide 87 comprises an accommodation 88 in which a swivel pin 89 of the swivel joint 82 is supported. If the hand levers 80, 81 are actuated in the closing direction, the pivot pin 89 transmits an actuating force to the slide 87 and thus to the actuating plunger 10 via the accommodation 88.

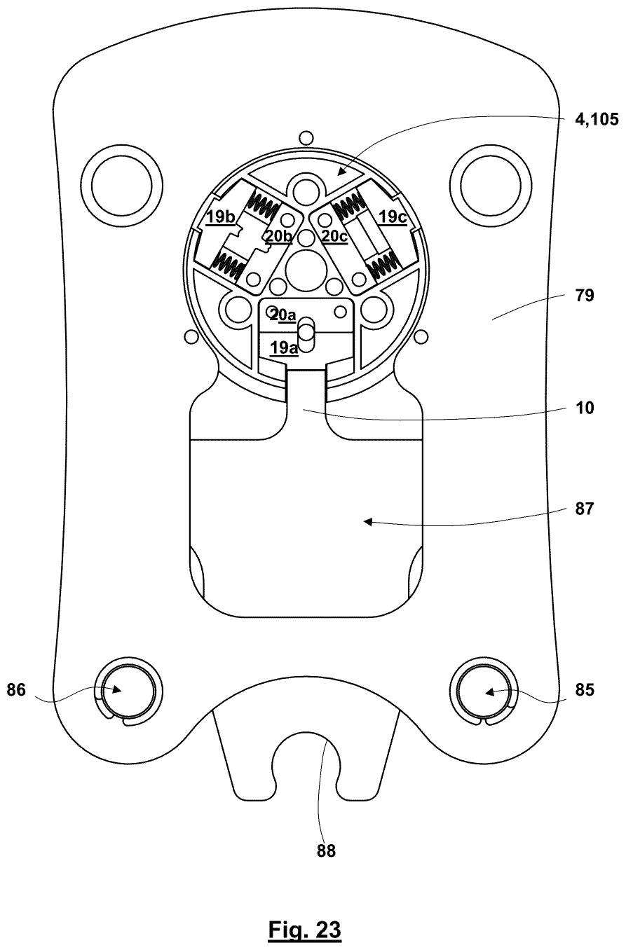

With regard to the basic design of the tool 1 shown in FIGS. 22 and 23, reference is e. g. made to the publications DE 100 56 900 C1 and EP 0 468 335 A2.

For this embodiment, the tool insert 4 is inserted directly into the tool head 79 and trapped between the two plates of the tool head 79. The rotary movement of the tool insert 4 can be guided via the outer surface of the revolver housing 13 and/or the outer surface of the cover 12 in an inner surface of a bearing lug of the tool head 79. It is possible that an additional covering lid (not shown in FIGS. 22 and 23) is attached to the tool head 79, which covers the tool insert 4 on the outside (except for access to the actuating plunger 10 and to the pair of respectively activated processing bodies 19, 20).

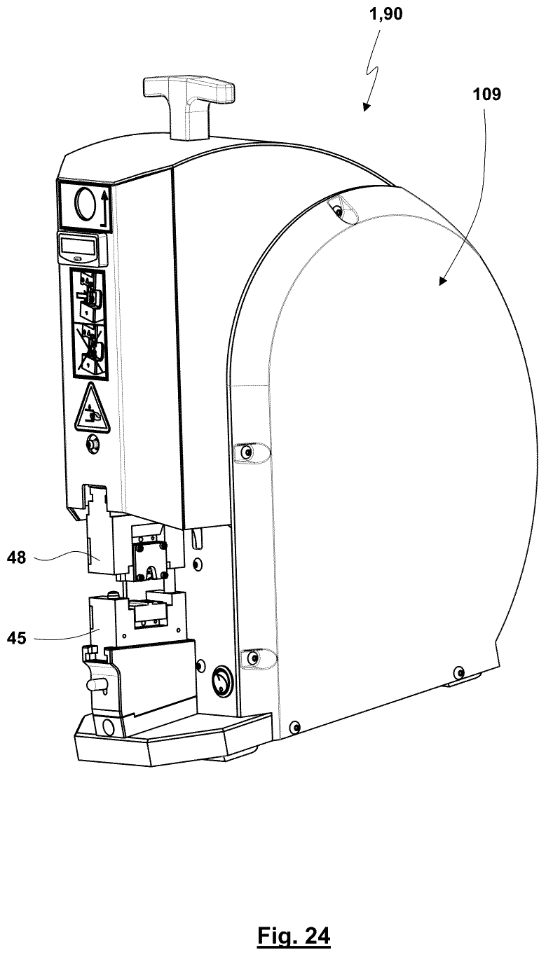

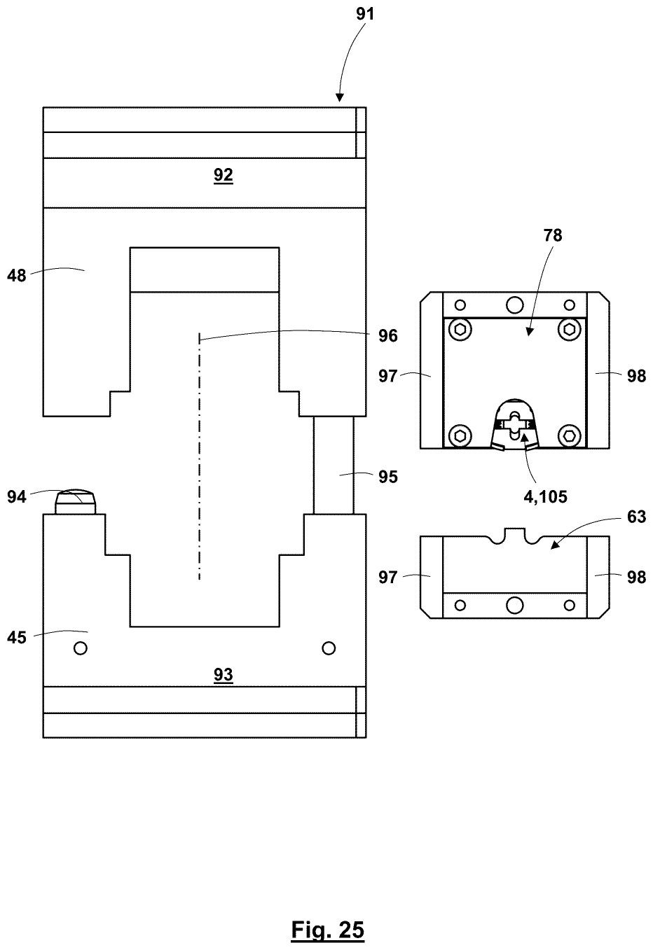

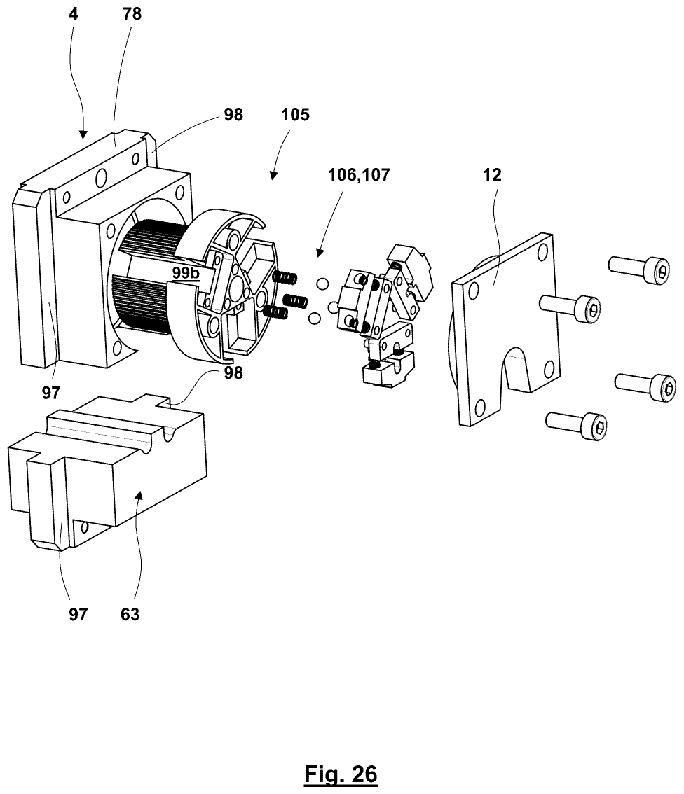

FIG. 24 shows an embodiment in which the tool 1 embodied as a crimping machine 90. The crimping machine 90 has a fixed tool jaw 45, which in this case can also be referred to as an anvil, and a movable tool jaw 48, which in this case can also be referred to as a punch. The crimping machine 90 has a guide unit insert 91 which has two guide parts 92, 93 (cf. FIGS. 25, 26). The guide parts 92, 93 are guided relative to each other via guide pins 94, 95, so that the guide parts 92, 93 can only perform a translatory movement in the direction of an actuating axis 96. It is possible that a displacement sensor and/or a sensor for sensing the actuating force is integrated in the crimping machine 90, in the tool jaws 45, 48 or in the guide parts 92, 93. Additional information in this regard can be found in publication EP 2 698 885 B1.

The actuating plunger insert 63 is mounted directly to the guide part 93. The tool insert 4 comprises a housing 78, which is mounted on the guide part 92.

The guide parts 92, 93 have T-shaped elongated protrusions in the area for the fastening on the tool jaws 45, 48. With these protrusions the guide parts 92, 93 can be slid into correspondingly shaped T-grooves of the tool jaws 45, 48.

The actuating plunger insert 63 and the housing 78 of the tool insert 4 have rib-shaped elongated protrusions 97, 98 in the region of the lateral side surfaces, which can be inserted in the vertical direction into corresponding vertically oriented grooves of the guide parts 92, 93 (not shown in the figures). In addition, the tool insert 4 can be fastened to the guide part 93 and on the other hand the housing 78 can be fastened to the guide part 92 by means of additional connections, in particular screws.

It is possible that (as shown in the figures) the actuating protrusion 32 comprises longitudinal grooves 99 which extend parallel to the rotational axis 16 and coaxially to the pairs of processing bodies 19, 20 and via which the accommodations 62 formed by the processing bodies 19, 20 are accessible.

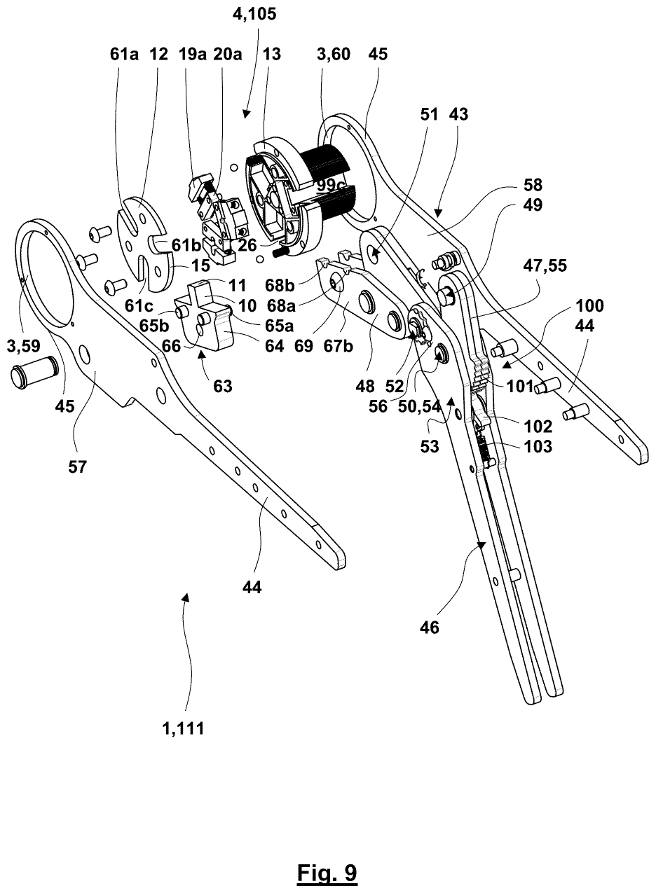

Furthermore, it is possible that the tool has a forced locking unit 100. A forced locking unit 100 serves to secure a configuration of the hand levers 44, 46 and the tool jaws 45, 48 reached after a part of the processing stroke against an undesired opening movement during the processing stroke, even if an actuating force, in particular the manual force applied by the user to the hand levers 44, 46, is temporarily removed. Instead, a forced locking unit 100 ensures that the hand levers 44, 46 and the tool jaws 45, 48 can only be opened when the processing stroke has been completed. An exemplary design of a forced locking unit 100 is explained with reference to FIG. 9. Here, the compression lever 47 has teeth 101. A blocking pawl 102, which is pivotably hinged to the movable hand lever 46 and is biased by a spring 103, engages with the teeth 101. With the closing movement of the movable hand lever 46, the pawl 102 slides along the teeth 101 like a ratchet, while the pawl 102 blocks an opening movement. Once the operating stroke has been completed, the pawl 102 swivels back in such a way that another side of the blocking tooth of the pawl 102 interacts with the teeth 101, allowing the pawl 102 to slide along the teeth 101 in a ratchet-like manner for the opening movement.

For the embodiment shown, the tool insert 4 was mounted on the fixed tool jaw 45, while the actuating plunger insert 63 was mounted on the movable tool jaw 48, if applicable. Reverse assembly, namely mounting the tool insert 4 on the movable tool jaw 48 and the actuating plunger insert 63 on the fixed tool jaw 45, is also possible.

For each of the illustrated embodiments, each pair of processing bodies 19, 20 forms an accommodation 62 for the workpiece comprising a longitudinal axis 104.

The tool insert 4 comprises a structural unit that can be rotated about the rotational axis 16 and which is comprises the revolver housing 13, the processing bodies 19, 20 and the springs 22, 23 and, if applicable, a housing 78. The revolver housing 13 (possibly with the parts rotated with the revolver housing) is also referred to here as revolver 105.

The latching elements 29 with the latching springs 28 biasing the latching elements 29 and the latching recesses 31 form a fixing device 106, which is embodied as a latching device 107.

For the embodiments shown, the tools 1 comprise the tool insert 4 on the one hand and a tool actuation unit 108 on the other hand, which serves to generate the actuation force by means of a drive or by an application of manual forces. The tool actuation unit 108 comprises the drive mechanism and comprises e. g. the hand levers 44, 46, 80, 81, the toggle lever 53, the compression lever 47, the slide 71, 78 and the pulling bars 83, 84 as well as the associated swivel joints.

In the embodiments shown in FIGS. 1 to 5; 6 to 9; 10 to 13; 14 to 16 and 21, 22, the tool 1 is in each case embodied as crimping pliers 111. Additional functions can be integrated into the crimping pliers 111 depending on the design of the processing bodies 19, 20, in particular a stripping function and/or a cutting function. It is also possible that the processing bodies 19, 20 of a crimping pliers 111 provide different die geometries.

In the crimping pliers 111, the tool actuation unit 108 is embodied as a manual pliers actuation unit 110. In contrast, for the crimping machine 90, the tool actuation unit 108 is embodied as a crimping machine actuation unit 109.

It is possible for all embodiments that one component, several components or all components of the tool 1, the crimping machine 90, the crimping pliers 111, the tool insert 4 or the tool actuation unit 108 is/are made of a biogenic material.

It is furthermore possible that the tool insert 4 is multifunctional, in that the tool insert is embodied
as a combined stripping and cutting unit or
as a combined stripping and crimping unit or
as a combined cutting and crimping unit or
as a combined stripping, cutting and crimping unit.

Many variations and modifications may be made to the preferred embodiments of the invention without departing substantially from the spirit and principles of the invention. All such modifications and variations are intended to be included herein within the scope of the present invention, as defined by the following claims.

I claim:

1. A tool comprising
a) a tool insert with a revolver which can be rotated about a rotational axis and comprises a first pair of processing bodies and a second pair of processing bodies, the processing bodies of each pair
aa) together forming an accommodation for a workpiece, the accommodation comprising a longitudinal axis and
ab) being movable during a processing stroke along a processing axis relative to each other and radially to the longitudinal axis from an open relative position into a closed relative position, such that a workpiece is processed between the processing bodies of the respective pair of processing bodies,
one of the processing bodies of each pair of processing bodies having an actuating surface and the processing axes of the first and second pair of processing bodies being oriented in different directions radially to the rotational axis relative to the revolver,
b) a tool actuating unit comprising an accommodation for the tool insert and an actuating plunger having an actuating surface,
c) wherein the revolver and the processing bodies of the first and second pair of processing bodies can be rotated together about the rotational axis from a first rotational position into a second rotational position and
d) in the first rotational position of the revolver the actuating surface of the actuating plunger of the tool actuating unit actuates the actuating surface of the one processing body of the first pair of processing bodies and in the second rotational position of the revolver the actuating surface of the actuating plunger of the tool actuating unit actuates the actuating surface of the one processing body of the second pair of processing bodies.

2. The tool of claim 1, wherein a fixing device is provided, by means of which it is possible to fix a rotational position of the revolver.

3. The tool of claim 2, wherein the fixing device is a latching device.

4. The tool of claim 2, wherein the fixing device is a locking device.

5. The tool of claim 1, wherein the tool actuating unit is a crimping machine actuating unit.

6. The tool of claim 1, wherein the tool actuating unit is a manual pliers actuating unit.

7. The tool of claim 6, wherein a base body of the manual pliers actuating unit forms hand levers and the actuating plunger as one single piece, a movement of at least one hand lever relative to the actuating plunger over the processing stroke being provided by an elastic deformation of the base body.

8. The tool of claim 6, wherein the manual pliers actuating unit
a) comprises a fixed tool part with a fixed tool jaw and a fixed hand lever,
b) comprises a movable hand lever,
c) comprises a movable tool jaw and
d) comprises a compression lever,
wherein
e) the movable tool jaw is linked to the fixed tool part via a first swivel joint,
f) the movable hand lever is linked via a second swivel joint to the movable tool jaw,
g) the compression lever is linked to the fixed tool part via a third swivel joint and is linked to the movable hand lever via a fourth swivel joint,
h) a toggle lever drive is formed in which
ha) the compression lever forms a first toggle lever,
hb) a section of the movable hand lever between the second swivel joint, by which the movable hand lever is linked to the movable tool jaw, and the fourth swivel joint, by which the compression lever is linked to the movable hand lever, forms a second toggle lever, and
hc) the fourth swivel joint, by which the compression lever is linked to the movable hand lever, forms a toggle joint,
i) wherein one tool jaw forms the accommodation for the tool insert and the other tool jaw comprises or supports the actuating plunger.

9. The tool of claim 6, wherein the manual pliers actuating unit comprises
a) a fixed tool part with a C-shaped tool head, which forms a fixed tool jaw, and with a fixed hand lever,
b) a slide, which is translationally displaceably guided on a tool head and forms a movable tool jaw,
c) a compression lever,
d) a movable hand lever,
wherein
e) the compression lever is linked to the fixed tool part via a first swivel joint and is linked to the movable hand lever via a second swivel joint,
f) the movable hand lever is linked to the slide via a third swivel joint,
g) a toggle lever drive is formed in which
ga) the compression lever forms a first toggle lever,
gb) a section of the movable hand lever between the third swivel joint, by which the movable hand lever is linked to the slide, and the second swivel joint, by which the compression lever is linked to the movable hand lever, forms a second toggle lever, and
gc) the second swivel joint, by which the compression lever is linked to the movable hand lever, forms a toggle joint,
h) wherein one tool jaw forms the accommodation for the tool insert and the other tool jaw comprises or supports the actuating plunger.

10. The tool of claim 6, wherein the manual pliers actuating unit comprises
a) an O-shaped tool head forming a fixed tool jaw,
b) a slide which is translationally displaceably guided on a tool head and forms a movable tool jaw,
c) two movable hand levers, which are linked to each other via a first swivel joint,
d) two pulling bars, which are each linked in one end region via a second swivel joint to an associated hand lever and in the other end region via a third swivel joint to the tool head,
wherein a swivel pin of the first swivel joint, by which the two hand levers are linked to one another, is arranged in an accommodation of the slide and an actuating force can be transmitted via a contact of the swivel pin with the accommodation of the slide.

11. The tool of claim 1, wherein
a) a tool jaw comprises an edge-open recess and the tool insert or a housing of the tool insert comprises a traverse carrier, wherein the tool insert or a housing of the tool insert is held replaceable on the tool jaw and the traverse carrier is arranged in the recess, and/or
b) a tool jaw comprises an edge-open recess and the actuating plunger comprises a traverse carrier, wherein the actuating plunger is held replaceably on the tool jaw and the traverse carrier is arranged in the recess.

12. A group of tools, each tool comprising
a) a tool insert with a revolver which can be rotated about a rotational axis and comprises a first pair of processing bodies and a second pair of processing bodies, the processing bodies of each pair
aa) together forming an accommodation for a workpiece, the accommodation comprising a longitudinal axis and
ab) being movable during a processing stroke along a processing axis relative to each other and radially to the longitudinal axis from an open relative position into a closed relative position, such that a workpiece is processed between the processing bodies of the respective pair of processing bodies,
one of the processing bodies of each pair of processing bodies having an actuating surface and the processing axes of the first and second pair of processing bodies being oriented in different directions radially to the rotational axis relative to the revolver,
b) a tool actuating unit comprising an accommodation for the tool insert and an actuating plunger having an actuating surface,
c) wherein the revolver and the processing bodies of the first and second pair of processing bodies can be rotated together about the rotational axis from a first rotational position into a second rotational position and
d) in the first rotational position of the revolver the actuating surface of the actuating plunger of the tool actuating unit actuates the actuating surface of the one processing body of the first pair of processing bodies and in the second rotational position of the revolver the actuating surface of the actuating plunger of the tool actuating unit actuates the actuating surface of the one processing body of the second pair of processing bodies,
wherein the group of tools comprises a first subgroup and a second subgroup, wherein the tools of the first subgroup and the tools of the second subgroup comprise different types of tool actuating units, but the same tool inserts.
